(19) United States
(12) Patent Application Publication
(10) Pub. No.: US 2008/0254699 A1
(43) Pub. Date: Oct. 16, 2008

(54) Flame Retardant Bedding Product

(76) Inventors: Wataru Mio, Kobe-shi (JP); Masanobu Tamura, Kobe-shi (JP); Masahiko Mihoichi, Kobe-shi (JP); Shigeru Maruyama, Takasago-shi (JP); Susumu Iwade, Osaka-shi (JP)

Correspondence Address: BIRCH STEWART KOLASCH & BIRCH, PO BOX 747, FALLS CHURCH, VA, 22040-0747, US

(21) Appl. No.: 11/885,363

(22) PCT Filed: Mar. 3, 2006
(86) PCT No.: PCT/JP2006/304117

§ 371 Date: Aug. 30, 2007

(30) Foreign Application Priority Data
Mar. 4, 2005 (JP) 2005-061258
Mar. 10, 2005 (JP) 2005-067559

(51) Int. Cl. D03D 15/12; B32B 27/36; B32B 9/00; D04H 13/00; D04B 1/00; B32B 33/00

(52) U.S. Cl. 442/302; 428/480; 428/446; 428/341; 442/304; 442/414

(57) ABSTRACT

A bedding product, such as a pillow or cushion, that satisfactorily drawing out peculiar softness and comfort possessed by an internal filling material, realizes comfort and high flame retardance without detriment to the excellent drape and tactile sensation possessed by a fiber material of flame shielding cloth. There is provided a flame retardant bedding product comprising an internal filling material covered by a flame shielding cloth made of fibers containing 5 to 60 wt. % halogenous fiber (A), 5 to 60 wt. % flame retardant cellulose fiber (B), 0 to 75 wt. % cellulose fiber (C) and 0 to 50 wt. % polyester fiber (D).

### TECHNICAL FIELD

The present invention relates to bedding products such as pillow, cushion, head board cushion for used on bed head plate, bed comforter, mattress pad, and futon. In particular, it relates to flame-retardant bedding products prepared by enclosing a filling material such as cotton, polyester fiber or feather with a flame-shielding fabric of a fiber containing a flame-retardant fiber.

### BACKGROUND ART

In bedding products, an inflammable raw material such as cotton, polyester fiber, or feather has been used as the internal filling material to make it softer. For preparing a flame-retardant bedding product, it is thus important to prevent ignition of the inflammable raw filling material for an extended period of time when exposed to flame by enclosing the filling material with a flame-shielding fabric. In addition, the flame-shielding fabric should also satisfy the requirements in comfortableness and design as a bedding product.

Various flame resisting fibers and flame-retardant chemicals have been studied for preparation of flame-shielding fabrics, but there is still no such products sufficiently satisfying the requirements in flame-shielding efficiency and also in comfortableness and design as a bedding product.

For example, there is a method of using a flame-shielding fabric subjected to so-called post-processing flameproofing of coating a flame-retardant chemical on a woven fabric such as cotton cloth. However, such a processing caused problems of unfavorable touch feeling and comfortableness as a bedding product, because of fluctuation in flame-proofing property caused by uneven application of the flame-retardant chemical and hardening of the woven fabric by application of the chemical. It also had a problem that the flame-proofing chemical was removed by washing, leading to deterioration of the flame-shielding property.

A fabric of an inorganic fiber such as glass fiber, when used as the flame-shielding fabric, is superior in flame resistance, but insufficient in hygroscopicity and touch feeling as a bedding product. Such an inorganic fiber had a problem of low processability during fiber opening and also a problem that it was difficult to print highly fashionable characters and drawings because of its low dye affinity.

Alternatively when a fabric containing a common raw material polyester as the principal component is used, the fabric melts by combustion, when exposed to flame, leaving holes and allowing ignition of the internal filling material, and thus, has completely no fire resisting property.

Also proposed were interior fiber products (Patent Document 1) and fiber products for bedding (Patent Document 2) using a flame-resisting fiber complex containing a halogen-containing fiber highly flame-resistant because of its flame retardant contained in a great amount and another non-flame-proofed fiber in combination. However, even by these methods, there were still problems to overcome in flame-shielding property, comfortableness and design as a bedding product.

Also proposed were a bulky flame-resistant nonwoven fabric containing a inherently flame-resistant fiber and a halogen-containing fiber (Patent Document 3), a flame-resistant nonwoven fabric containing a halogen-containing polyacrylonitrile fiber and a fiber supporting the fiber during combustion (Patent Document 4), and flame-resistant nonwoven fabric containing a flame-resistant rayon fiber, a flame-resistant acrylic fiber, and a flame-resistant melamine fiber (Patent Document 5). However, the filling materials, such as cotton, used in beddings and furniture obtained by these methods were insufficient in softness and comfortableness, compared to the properties of their own, and thus, lower in comfortableness. In addition, these methods use a nonwoven fabric, and the products having such a nonwoven fabric as the surface fabric were lower in softness to skin and flexibility than those having a knitted fabric.

Patent Document 1: Japanese Unexamined Patent Publication No. H05-106132

Patent Document 2: Japanese Unexamined Patent Publication No. H05-093330

Patent Document 3: WO 03/023108

Patent Document 4: U.S. Patent No. 2004/0062912A1

Patent Document 5: U.S. Patent No. 2004/0097156A1

### DISCLOSURE OF THE INVENTION

### Technical Problems to be Solved

An object of the present invention, which was made under the circumstances described above, is to provide, by enclosing a filling material such as cotton, polyester fiber, or feather with a highly flame-retardant flame-shielding fabric, a comfortable and highly flame-resistant bedding product that retains the softness and the comfortableness inherent to the filling material sufficiently and also the superior texture and touch feeling inherent to the raw fiber material of flame-shielding fabric.

### Means to Solve the Problems

After intensive studies to solve the problems above, the inventors have found that it was possible to obtain a flame-retardant bedding product satisfying the requirements in texture and touch feeling demanded when processed into a bedding product such as cushion, pillow, comforter, of mattress pad and having a favorable flame resistance withstanding flame for an extended period of time by preparing a flame-shielding fabric with a fiber containing a halogen-containing fiber (A) and a flame-retardant cellulosic fiber (B) as essential components, and also as needed a cellulosic fiber (C) and a polyester fiber (D) and covering a filling material such as cotton, polyester fiber or feather with the fabric.

Accordingly, the flame-retardant bedding product according to the present invention characteristically comprises a filling material and a flame-shielding fabric enclosing the same of a fiber containing 5 to 60 wt % of a halogen-containing fiber (A), 5 to 60 wt % of a flame-retardant cellulosic fiber (B), 0 to 75 wt % of a cellulosic fiber (C), and 0 to 50 wt % of a polyester fiber (D).

The halogen-containing fiber (A) is preferably a modacrylic fiber. The “modacrylic” resin means a resin containing acrylonitrile in an amount of 35 wt % or more and less than 85 wt %.

The flame-retardant cellulosic fiber (B) is preferably at least one fiber selected from the group consisting of cotton, hemp, rayon, polynosic, cupra, acetate and triacetate containing an additional flame retardant.

The flame-retardant cellulosic fiber (B) is more preferably a rayon fiber containing a flame retardant selected from silicic acid and aluminum silicate in an amount of 20 to 50 wt %.

The flame-retardant cellulosic fiber (B) may be a cellulosic fiber containing at least one flame retardant selected from the group consisting of phosphate eater compounds, halogen-containing phosphate eater compounds, condensed phosphate eater compounds, polyphosphate salt compounds, red phosphorus, amine compounds, boric acid, halogen compounds, bromides, urea-formaldehyde compounds, phosphate salt-urea compounds, ammonium sulfate, in an amount of 6 to 25 wt % with respect to the cellulosic fiber.

The cellulosic fiber (C) is preferably at least one fiber selected from the group consisting of cotton, hemp, rayon, polynosic, cupra, acetate and triacetate, and more preferably at least one fiber selected from the group consisting of cotton, hemp, and rayon.

The polyester fiber (D) is preferably a polyester-based low-melting-point binder fiber or a fiber consisting of a common polyester fiber and a low-melting-point binder fiber.

The low-melting-point binder fiber of the polyester fiber (D) is preferably at least one fiber selected from the group consisting of single-component low-melting-point polyester fibers, composite fibers of a common polyester and a low-melting-point polyester, and composite fibers of a common polyester and a low-melting-point polyolefin.

The flame retardant is preferably contained in an amount of 1.0 to 40 wt % in the flame-shielding fabric.

More preferably, a Sb compound is contained in the flame-shielding fabric in an amount of 0.2 to 20 wt %.

The filling material is preferably at least one material selected from the group consisting of cellulosic fiber, polyester fiber, and feather.

The filling material is preferably a bulky polyester fiber. The “bulky polyester fiber” is a composite fiber in the side-by-side structure of polyesters having different melting points, which is made bulkier in the spiral structure by application of heat.

The basis weight of the flame-shielding fabric is preferably 150 g/m² or less.

The flame-shielding fabric enclosing the filling material is preferably at least one fabric selected from the group consisting of woven fabric, knitted fabric, and nonwoven fabric.

Preferably, the flame-shielding fabric is a woven or knitted fabric and used as a surface fabric for bedding products.

Alternatively, the flame-shielding fabric may be a nonwoven fabric and used as an internal fabric, as placed between the surface fabric and the filling material.

### Advantageous Effects of the Invention

The flame-retardant bedding product according to the present invention is a comfortable and highly flame-resistant bedding product that retains the softness and the comfortableness inherent to the raw filling material sufficiently and also the superior texture and touch feeling inherent to the raw fiber material for flame-shielding fabric, comprising a filling material and a flame-shielding fabric enclosing the same of a fiber containing 5 to 60 wt % of a halogen-containing fiber (A), 5 to 60 wt % of a flame-resistant cellulosic fiber (B), 0 to 75 wt % of a cellulosic fiber (C), and 0 to 50 wt % of a polyester fiber (D).

### BEST MODE OF CARRYING OUT THE INVENTION

As described above, the flame-retardant bedding product according to the present invention is a flame-retardant bedding product in which a filling material is enclosed with a flame-shielding fabric.

Examples of the flame-retardant bedding product according to the present invention include, but are not limited to, pillow, cushion, futon, head board cushion for use on bed head board, mattress pad, and comforter.

Examples of the filling materials for use in the present invention include cotton, polyester fiber, feather, and the like. The filling material is preferably a cellulosic or polyester fiber, from the points of softness and hygroscopicity, and these fibers may be used as mixed. In particular for improvement of the bedding product in design, product strength, washing resistance, durability, and others, use of a common polyester fiber containing no flame retardant or other additives or a bulky polyester fiber is desirable.

Alternatively, feather may be used as the filling material, and there are many kinds of feathers, for example, feather with quill and feather (down) without quill, but the feather is not particularly limited, if it is used generally for bedding products. Examples of the birds from which the feather is collected generally include, but are not limited to, kites and ducks in Anseriformes species. Use of the feather as a filling material increases the air content per unit mass, making the bedding product warmer and lighter. Bedding products containing a filling material of feather are characterized in that (1) they are superior in water-absorbing/releasing property and thus comfortable, (2) they fit to the body because the feather does not entangle with each other, (3) they are superior in elastic recovery and softness, and (4) they are superior in water-releasing property and thus easier in handling. In particular, use of a feather containing no flame retardant or other additives is more preferable.

Normally, bedding products containing such a filling material are extremely inflammable, but it is possible to prevent spread of fire to the internal filling material when a bedding product is exposed to flame, by enclosing the filling material with the flame-shielding fabric described below in detail.

The flame-shielding fabric for use in the present invention is made of a fiber containing a halogen-containing fiber (A) and a flame-resistant cellulosic fiber (B) as essential components and as needed a cellulosic fiber (C) and a polyester fiber (D), and the flame-shielding fabric containing at least two kinds of fibers is prepared, for example, by fiber mixing, mixed spinning, mixed weaving, or lamination of fabrics, but the method is not limited thereto.

The term flame-shielding indicates that the fiber in the configuration described above carbonizes while preserving the shape of the fiber when exposed to flame, and thus, shields the flame and prevents fire from spreading to the rear side. Specifically, it is possible to prevent firing of the filling material during fire and minimize the damage, by using a flame-shielding fabric between the surface fabric and internal filling material of a bedding product or by using a flame-shielding fabric as the surface fabric.

The halogen-containing fiber (A) is a component used for improvement of the flame resistance of the flame-shielding fabric that increases the self-flame-extinguishing efficiency of the surface by generating an oxygen-deficient gas during combustion. The halogen-containing fiber (A) for use in the present invention is, for example, a homopolymer or a copolymer of a halogen-containing monomer such as vinyl chloride or vinylidene chloride. The other the fibers (A) include copolymers of the halogen-containing monomer above and another monomer copolymerizable with the halogen-containing monomer. The monomer copolymerizable with the halogen-containing monomer is, for example, acrylonitrile, styrene, vinyl acetate, acrylic ester, or the like. Other examples of the fiber (A) include, but are not limited to, fibers of a graft polymer of a PVA-based polymer graft-polymerized with a halogen-containing monomer. Among the halogen-containing fibers (A) above, use of a fiber of a copolymer of a halogen-containing monomer and acrylonitrile, i.e., modacrylic fiber, is preferable, for providing the flame-shielding fabric with favorable flame resistance and also with superior texture, touch feeling, and design.

A flame retardant is preferably added to the modacrylic fiber for improvement in flame resistance of the flame-shielding fabric, and typical examples thereof include antimony compounds such as antimony trioxide, antimony pentoxide, antimonic acid, and antimony oxychloride; Sn compounds such as stannic oxide, metastannic acid, stannous oxyhalides, stannic oxyhalide, stannous hydroxide, and tin tetrachloride; Zn compound such as zinc oxide; Mg compounds such as magnesium oxide and magnesium hydroxide; Mo compounds such as molybdenum oxide; Ti compounds such as titanium oxide and barium titanate; N compounds such as melamine sulfate and guanidine sulfamate; P compounds such as ammonium polyphosphate and dibutylamino phosphate; Al compounds such as aluminum hydroxide, aluminum sulfate and aluminum silicate; Zr compounds such as zirconium oxide; Si compounds such as silicate and glass, natural or synthetic mineral compounds such as kaolin, zeolite, montmorillonite, talc, pearlite, bentonite, vermiculite, diatomaceous earth, and graphite; halogen compounds such as chlorinated paraffins, hexabromobenzene, and hexabrocyclododecane. In addition, composite compounds such as magnesium stannate, zinc stannate, and zirconium stannate are also usable. These compounds may be used alone or in combination of two or more. Among them, antimony compounds are preferable, because they show extremely high flame resistance, by reacting with the halogens atom released from the modacrylic fiber and generating antimony halides during combustion. The antimony compound is preferably added in an amount of 0.2 wt % or more with respect to the entire flame-shielding fabric for preservation of the flame resistance of the flame-shielding fabric, and in an amount of 20 weight % or less with respect to the entire flame-shielding fabric for prevention of the damage in texture and strength of the flame-shielding fabric. Typical examples of the modacrylic resins include, but are not limited to, Kanekaron manufactured by Kaneka Corporation and SEF available from Solutia.

The flame-retardant cellulosic fiber (B) for use in the present invention is used for improvement in the flame resistance and preservation of the strength of the flame-shielding fabric, and is a component that makes the fabric more comfortable, for example, with superior texture and hygroscopicity and is effective in forming a carbonized film during combustion.

Examples of the flame-retardant cellulosic fibers (B) for use in the present invention include silicic acid-containing cellulosic fibers containing a cellulosic fiber and a flame retardant silicic acid and/or aluminum silicate, flame-retardant cellulosic fibers containing other flame retardant added during production, and flame-retardant cellulosic fibers (B) flame-proofed, for example, by post-processing using a flame retardant. Typical examples of the cellulosic fiber, a raw material of the flame-retardant cellulosic fiber (B), include cotton, hemp, rayon, polynosic, cupra, acetate and triacetate, and these materials may be used alone or in combination of two or more.

The silicic acid-containing cellulosic fiber contains silicic acid and/or aluminum silicate as a flame retardant in an amount of 20 to 50 wt % in the fiber, and has a fineness of normally, approximately 1.7 to 8 dtex and a cut length of approximately 38 to 128 mm. Typical examples thereof include, but are not limited to, Visil manufactured by Sateri containing silicic acid in an amount of approximately 30 wt % in the fiber, Visil AP manufactured by Sateri containing aluminum silicate in an amount of approximately 33 wt % in the fiber, other flame-retardant cellulosic fibers such as Lenzing FR manufactured by Lenzing A. G., and the like.

Examples of the flame retardants used in flame-proofing processing, for example, in post-processing of the cellulosic fiber include phosphate ester compounds such as triphenyl phosphate, tricresyl phosphate, trixylenyl phosphate, trimethyl phosphate, triethyl phosphate, cresylphenyl phosphate, xylenyl diphenyl phosphate, resorcinol bis(diphenylphosphate), 2-ethylhexyl diphenyl phosphate, dimethyl methyl phosphate, triallyl phosphate (Reophos), aromatic phosphate esters, phosphonocarboxylic amide derivatives, tetrakis-hydroxymethylphosphonium derivatives, and N-methylol-dimethylphosphonopropionamide. Other examples of the flame retardant used, for example, in postprocessing for flame resistance include halogen-containing phosphate ester compounds such as tris(chloroethyl) phosphate, trisdichloropropyl phosphate, tris-β-chloropropyl phosphate, chloroalkyl phosphate, tris(tribromoneopentyl) phosphate, diethyl-N,N-bis(2-hydroxyethyl)aminomethyl phosphate, and tris(2,6-dimethylphenyl) phosphate; condensed phosphate ester compounds such as aromatic condensed phosphate esters and halogen-containing condensed phosphate eaters; polyphosphate salt compounds such as ammonium polyphosphate -amide and polychlorophosphonates; and polyphosphate ester compounds such as carbamate polyphosphate. Other examples include red phosphorus, amine compounds, boric acid, halogen compounds, bromides, urea-formaldehyde compounds, phosphate salt-urea compounds such as phosphorus-containing aminoplast, ammonium sulfate, guanidine-based condensates, and the like. These flame retardants may be used alone or in combination of two or more. The addition amount is preferably 6 to 25 wt % with respect to the cellulosic fiber. It is preferably added in an amount of 1 wt % or more with respect to the entire flame-shielding fabric for preservation of the flame resistance of the flame-shielding fabric, and in an amount of 20 wt % or less with respect to the entire flame-shielding fabric for prevention of the damage in texture of the flame-shielding fabric.

The cellulosic fiber (C) for use in the present invention is a component that is effective in preserving the strength of the flame-shielding fabric and in making it more comfortable, for example, with superior texture and hygroscopicity and also in forming carbonized film during combustion. Typical examples of the cellulosic fiber (C) include cotton, hemp, rayon, polynosic, cupra, acetate and triacetate, and these fibers may be used alone or in combination of two or more. In particular, cotton, hemp, and rayon fiber are preferable from the viewpoints of texture and hygroscopicity.

The polyester fiber (D) for use in the present invention is a component that provides the flame-shielding fabric according to the present invention with excellent texture, touch feeling, design, product strength, washing resistance, and durability, and is effective in improving the strength of the carbonized film, by covering the film with the molten resin during combustion although the polyester fiber (D) itself is flammable.

In addition, a polyester-based low-melting-point binder fiber allows use of a simple and convenient hot-melt adhesion method during processing of the flame-shielding fabric into nonwoven fabric. The polyester-based low-melting-point binder fiber for use may be a single low-melting-point polyester fiber. Alternatively a side-by-side fiber or core/shell composite fiber of a common polyester and at least one fiber selected from the group consisting of low-melting-point polypropylenes, low-melting-point polyethylenes and low-melting-point polyesters may be used as the polyester-based low-melting-point binder fiber. Generally, the melting point of the low-melting-point polyester is approximately 110 to 200° C.; the melting point of the low-melting-point polypropylene, approximately 140 to 160° C.; and the melting point of the low-melting-point polyethylene, approximately 95 to 130° C.; and the binder fiber is not particularly limited, if it allow hot-melt adhesion at approximately 110 to 200° C. Examples of the low-melting-point binder fiber include, but are not limited to, Safmet manufactured by Toray Industries, Inc. (4.4 dtex×51 mm, melting temperature: 110° C.). On the other hand, the “common polyester” according to the present invention is a polyester having a melting point higher than that of the low-melting-point polyester above. In preparing a nonwoven fabric by thermal bonding method, a low-melting-point polyester fiber above is favorably used as the low-melting-point binder fiber.

The basis weight of the flame-shielding fabric for use in the present invention is preferably larger from the viewpoint of flame-shielding efficiency, but preferably 250 g/m² or less for prevention of deterioration in touch feeling of the filling material. The lower limit of the basis weight is preferably 80 g/m² or more, for prevention of release of the filling material from the bedding product. When feather is used as the filling material, the basis weight is more preferably 200 g/m² or less for taking the advantage of the softness of feather.

The content of the flame retardant in the entire flame-shielding fabric for use in the present invention is preferably 1.0 wt % or more. A content of the flame retardant in the entire fabric of less than 1.0 wt % may lead to insufficient self-extinguishing capacity during combustion, and consequently to firing of the filling material used in bedding products.

In the present invention, a flame-shielding fabric containing a cellulosic fiber (C) and/or a polyester fiber (D) is used, for further improvement of the comfortableness such as the texture, hygroscopicity, durability and self-extinguishing of the flame-shielding fabric. The ratio of the halogen-containing fiber (A), flame-resistant cellulosic fiber (B), cellulosic fiber (C) and polyester fiber (D) is determined according to requirements in the comfortableness such as texture and hygroscopicity needed as the bedding product, washing resistance, durability, strength of flame-shielding fabric, easiness in forming carbonized film, and self-extinguishing velocity. The content of the halogen-containing fiber (A) is 5 to 60 wt %, preferably 10 to 60 wt %. The content of the flame-retardant cellulosic fiber (B) is 5 to 60 wt %, preferably 10 to 60 wt %. The content of cellulosic fiber (C) is 0 to 75 wt %, preferably 0 to 65 weight %. The content of polyester fiber (D) is 0 to 50 wt %, preferably 0 to 40 weight %. The halogen-containing fiber (A) is the main component giving the flame-shielding fabric self-extinguishing property, and a halogen-containing fiber (A) content of less than 5 wt % leads to insufficient flame-shielding efficiency, and self-extinguishing property of the flame-shielding fabric, while a content of more than 60 wt % to decrease in the content of carbonization component and deterioration of the flame-shielding efficiency. The flame-retardant cellulosic fiber (B) is the main component in forming the carbonized film when the flame-shielding nonwoven fabric is carbonized, and a flame-retardant cellulosic fiber (B) content of less than 5 wt % unfavorably leads to deterioration of the carbonized film-forming efficiency of the flame-shielding nonwoven fabric, while a content of more than 60 wt % to unfavorable texture and comfortableness, because the fabric is less favorable in touch feeling than non-flame-proofed cellulosic fibers. Addition of the cellulosic fiber (C) is effective in giving comfortableness such as superior texture and hygroscopicity. Although the cellulosic fiber (C) is also a carbonizing component and thus may improve the flame-shielding efficiency of the flame-shielding fabric, a cellulosic fiber (C) content of more than 75 wt % is unfavorable, as it leads to increase of the inflammable component in the flame-shielding fabric and to insufficient flame-shielding efficiency. Addition of the polyester fiber (D) would be effective in improving washing resistance and durability. Although the polyester fiber (D) is effective in improving the carbonized film strength by covering the carbonized flame-shielding fabric with the resin melted during combustion, as the polyester fiber (D) is inflammable, a content of more than 50 wt % is undesirable, because it leads to increase of the inflammable component in the flame-shielding fabric and deterioration of the flame-shielding efficiency.

The flame-shielding fabric for use in the present invention contains a halogen-containing fiber (A) and a flame-retardant cellulosic fiber (B) as the essential components. The halogen-containing fiber (A) is highly self-extinguishing, and in particular, a halogen-containing fiber (A) containing an antimony compound, when used as mixed with a non-self-extinguishing fiber, extinguishes the flame on the fabric rapidly, together with the non-self-extinguishing fiber. On the other hand, the halogen-containing fiber (A) itself does not have a strong carbonization-accelerating effect, and the carbonized film formed is not strong enough and contracts when exposed to flame. In contrast, the flame-retardant cellulosic fiber (B), although self extinguishing itself, acts weakly as a flame retardant to the non-self-extinguishing fiber. However, because the raw material is a cellulosic fiber, it has a strong carbonization-accelerating effect and gives a stabilized carbonized film with smaller shrinkage by rapid carbonization when exposed to flame. It is thus possible to provide a flame-shielding fabric with high self-extinguishing property, and make it form a strong carbonized film shielding the flame during combustion by using a halogen-containing fiber (A) and a flame-resistant cellulosic fiber (B) in combination.

Among flame-retardant cellulosic fibers (B), a silicic acid-containing rayon fiber has problems of low fiber flexibility and fiber breakage during processing such as carding, because of the silicic acid contained. On the other hand, the flame-retardant cellulosic fiber by post-processing causes problems such as separation of the flame retardant during long-term use and associated deterioration in flame resistance, and the separation of flame retardant is undesirable, because the bedding product becomes in direct contact with skin. It is possible to solve these problems too, because the content of the flame-retardant cellulosic fiber (B) in the flame-shielding fabric can be reduced by using a halogen-containing fiber (A) in combination.

When the flame-shielding fabric is a woven fabric, the fabric may be plain weave, twill weave, or satin weave and is not particularly limited. Such a woven fabric characteristically allows free designing, for example, by cotton dyeing, yarn dyeing, cloth dyeing, or printing, and the degree of freedom in designing is particularly important when it is used as the surface fabric. Another characteristic of the woven fabric is that the texture and the comfortableness inherent to the raw filling material are more distinct when the woven fabric is used, because the-thickness thereof is smaller than that when a nonwoven fabric is used.

When the flame-shielding fabric is a knitted fabric, the texture and comfortableness inherent to the raw filling material are more distinct, because the fabric is expandable both in the length and width directions and has a thickness smaller than that of nonwoven fabric. The fiber generally contracts in forming a carbonized film during combustion and the less-flexible carbonized film often shows cracking, but use of a knitted fabric, which is expandable both in the length and width directions, is effective in giving an extremely favorable carbonized film without cracking. The weaving method of the flame-shielding knitted fabric is not particularly limited, and may be weft knitting or warp knitting. The shape of the knitted fabric is also not particularly limited, and a surface-raised pile-shaped knitted fabric may be used.

When the flame-shielding fabric is a nonwoven fabric, there is no need for preparing yarn for the fabric, differently from woven fabric or knitted fabric, and the fabric may be produced directly with cotton. Thus, it is characteristic in that the degree of freedom in determining the blending ratio of raw materials is higher. A nonwoven fabric is more expandable during combustion than a woven fabric and characteristically resistant to cracking of the carbonized film, similarly to knitted fabrics. The production method for the nonwoven fabric is not particularly limited, and any commonly known method such as needle-punch method, thermal-bonding method, chemical-bonding method, water-jet method, or stitch-bonding method may be used.

The flame-shielding fabric for use in the present invention may contain, as needed, other additives such as antistatic agent, anti-heat-coloring agent, light stability improver, whiteness improver, and matting inhibitor, in the range that does not impair the characteristics of the components (A) to (D).

The flame-shielding fabric thus obtained is high flame-resistant, superior in texture, touch feeling, and hygroscopicity, and also superior in dye affinity and appearance.

The flame-shielding fabric for use in the present invention may be used in the shape of a common woven fabric, knitted fabric or pile knitted fabric as the surface fabric for a bedding product, or may be used in the shape of a woven fabric, knitted fabric, or nonwoven fabric, as it is held between the surface fabric and the filling material. When the flame-shielding fabric is used as the surface fabric, it is used, replacing the conventional surface fabric. When the flame-shielding fabric is used as an internal fabric held between the surface fabric and the filling material, the flame-shielding fabric is preferably held in the shape of a nonwoven fabric as it is held between the surface fabric of a conventional fabric and the filling material. Alternatively, the flame-shielding fabric may be used both as the surface and internal fabrics, i.e., two flame-shielding fabrics may be used as piled. Needless to say, when the flame-shielding fabric is used as an internal fabric held between the surface fabric and the filling material, the entire internal filling material is enclosed with the flame-shielding fabric, which is further enclosed with another surface fabric.

Such a flame-shielding fabric is highly flame-resistant, and yet retains the superior texture, touch feeling, hygroscopicity, durability, and others inherent to the raw fiber material. By enclosing the filling material with such a flame-shielding fabric, it is possible to obtain the softness and comfortableness inherent to the raw filling material sufficiently and give a bedding product superior in texture, touch feeling, hygroscopicity, and others and higher in flame resistance.

### EXAMPLES

Hereinafter, the present invention will be described in more detail with reference to Examples, but it should be understood that the present invention is not limited to the Examples.

(Method of Preparing Cushion for Flame-Resistance Evaluation)

(1) Method of Preparing a Cushion for Flame-Resistance Evaluation According to Section 1 by Using a Polyester Fiber as a Filling Material

A multilayered nonwoven fabric having a height of 4 inches was prepared as filling material for a cushion, for example for quilt, by using a polyester fiber with its web aligned uniformly in one direction in a particular amount (amount shown in Table 4 or 5) and cut into pieces of 12 inch in length×12 inch in width. The nonwoven fabric (filling material) was placed on the half region of a fabric cut to a piece of 15 inches in length×30 inches in width (15 inches in length×15 inches in width); a Plexiglas plate having a weight of 325 g (12 inch×12 inch×⅛ inch) was placed thereon, and the composite was adjusted to a height of 4±0.5 inch; and then, the fabric was folded into two, and the three bases thereof were woven with a cotton thread, giving a cushion for quilt. Two fabrics enclosing the filling material may be used. The fabric for use will be described below in detail.

(2) Method of Preparing a Cushion for Flame-Resistance Evaluation According to Section 2 by Using a Polyester Fiber as a Filling Material

A polyester fiber in a particular amount (amount shown in Table 6 or 7) is added to a filling material for a cushion, for example for pillow; the filling material was enclosed with one or two layers of a fabric completely; and the periphery was closed completely with a cotton thread, to give a pillow of 13 inches in length×13 inches in width.

(3) Method of Preparing Cushion for Flame-Resistance Evaluation According to Section 1 by Using Feather as a Filling Material

A cushion for flame-resistance evaluation was prepared by using feather in the amount shown in Tables 8 to 10 as the internal filling material, enclosing the filling material with a layer of fabric completely, and weaving the periphery of the fabric completely with a cotton thread. The fabric was cut into pieces of 15 inches×30 inches; a feather having a bottom area of 12 inches×12 inches was piled on half region thereof (region of 15 inches×15 inches); a 325-g Plexiglas plate (12 inch×12 inch×⅛ inch) was placed thereon and the composite was adjusted to a height of 4±0.5 inches; the fabric was folded; and the three bases thereof were closed with a cotton thread, to give a cushion. The feather used was washed duck feather. Two fabrics may be used in enclosing the filling material. The fabric for use will be described below in detail.

(3) Method of Preparing a Cushion for Flame-Resistance Evaluation According to Section 2 by Using Feather as Filling Material

25 g of feather was used in preparing a cushion for flame-resistance evaluation; the feather was enclosed completely with one or two layers of fabric; and the periphery of the fabric was closed completely by sawing with a cotton thread, to give a cushion of approximately 13 inches in length×approximately 13 inches in width.

The flame resistance of the flame-retardant bedding products prepared by using the cushions for flame-resistance evaluation (1) to (4) was determined according to Section 1 or 2 of the draft for Technical Bulletin 604, published in October 2003 (hereinafter, TB604) in the combustion test method of U.S. California State.

(Method of Evaluating Flame Resistance)

Evaluation of the flame resistance of the bedding products obtained in Examples is performed according to the method in Section 1 or 2 of the draft for Technical Bulletin 604, published in October 2003 (hereinafter, TB604) in the combustion test of U.S. California State, by using the cushions for flame-resistance evaluation prepared by the methods of preparing a cushion for flame-resistance evaluation (1) to (4). Briefly in the TB604 in the combustion test method of U.S. California State, a flame of 35 mm in size is applied to a cushion in the right forward direction from a position at ¾ inch from the bottom for 20 seconds in the case of a cushion for quilt (Section 1), and the cushion satisfies the requirement in the weight-decrease rate after 6 minutes of 25 wt % or less. Alternatively in the case of a cushion, for example for pillow, (Section 2), the cushion satisfying the weight-decrease rate after 6 minutes of 20 wt % or less as determined in a similar combustion test is satisfactory. The burner tube used then has an internal diameter of 6.5 mm, an external diameter of 8 mm, and a length of 200 mm. The fuel gas used is a butane gas at a purity of 99% or more, and the length of the flame at a butane gas flow rate of 45 ml/min is approximately 35 mm.

The flame resistance test of flame-resistant cushions obtained in Examples was performed in a procedure similar to the combustion test procedure; in evaluation of the flame-retardant level in the case of a cushion for quilt (Section 1), a cushion having a weight-decrease rate 360 seconds after ignition of 25 wt % or less and a weight loss completion time of less than 360 seconds after ignition was indicated by ◯; a cushion having a weight-decrease rate 360 seconds after ignition of 25 wt % or less and a weight loss incompletion time of longer than 360 seconds after ignition, by Δ; and a cushion having a weight-decrease rate 360 seconds after ignition of more than 25 wt %, by ×. On the other hand, in the case of a cushion, for example for pillow, (Section 2), a cushion having a weight-decrease rate 360 seconds after ignition of 20 wt % or less and a weight loss completion time of less than 360 seconds after ignition was indicated by ◯; a cushion having weight-decrease rate 360 seconds after ignition of 20 wt % or less and a weight loss incompletion time of longer than 360 seconds after ignition, by Δ; and a cushion having a weight-decrease rate 360 seconds after ignition of more than 20 wt %, by ×.

As for the carbonized film after combustion test, a carbonized film resistant to damage and cracking when bent with fingers after combustion is indicated by ◯; a carbonized film having no damage after combustion but vulnerable to cracking when bent with fingers, by Δ; and a carbonized film having cracks and holes after combustion, by ×. Cushions having ◯ in all tests were rated ◯ (satisfactory) as overall flame-retardant rating, and the other cushions were rated×(unsatisfactory).

Preparative Example of Halogen-Containing Fiber (A) 1

52 wt parts of acrylonitrile, 46.8 wt parts of vinylidene chloride, and 1.2 wt parts of sodium styrenesulfonate were copolymerized, to give a copolymer, which was dissolved in acetone to a concentration of 30 wt %. Then, 15 wt parts of antimony trioxide was added thereto with respect to 100 wt parts of the copolymer, to give a spinning dope. The spinning dope obtained was extruded through a nozzle having 33,000 nozzle holes of 0.07 mm in size into 38 wt % aqueous acetone solution at 25° C., and the resulting fiber was washed with water, and dried at 120° C. for 8 minutes. Then, the fiber was drawn three times at 150° C. and heat-treated at 175° C. for 30 seconds, to give a halogen-containing fiber (A) having a fiber fineness of 2 dtex. The halogen-containing flame resisting fiber obtained was crimped while a fiber finishing oil (manufactured by Takemoto Oil & Fat Co., Ltd.) was supplied, and then, cut to a length of 51 mm.

Preparative Example of Flame Resistance Rayon Fiber (B) 1

20 wt parts of a flame retardant ammonium polyphosphate (FCP-730, manufactured by Suzuhiro Chemical Co., Ltd.) was added and adhered to a rayon (fiber fineness: 1.5 dtex, cut length: 38 mm) fiber, with respect to 100 wt parts of the rayon fiber.

Preparative Examples of Spun Yarns 1 to 6

As shown in Preparative Examples of spun yarns 1 to 6 in Table 1, the halogen-containing fiber (A) prepared in Preparative Example of halogen-containing fiber (A) 1, a silicic acid-containing rayon fiber (B) Visil manufactured by Sateri (fiber fineness: 1.7 dtex, cut length: 40 mm), the flame resistance rayon fiber (B) prepared in Preparative Example of flame resistance rayon fiber 1, a cotton fiber (C), and a polyester fiber (D) (fiber fineness: 1.7 dtex, cut length: 51 mm) were used at the ratio shown in Preparative Example and spun into a spun yarn having a metric count of 51 by a known method. In Preparative Example 6, two kinds of fibers were mixed in a carding machine.

TABLE 1
Preparative Examples of spun yarns

| Preparative Example | | |
|---|---|---|
| number of spun yarn | Used fibers | Ratio of fibers |
| Preparative Example 1 | Preparative Example of halogen-containing fiber (A) 1 | 100% |
| Preparative Example 2 | Silicic acid-containing rayon fiber (B) | 100% |
| Preparative Example 3 | Preparative Example of flame-retardant rayon fiber (B) 1 | 100% |
| Preparative Example 4 | Cotton fiber | 100% |
| Preparative Example 5 | Polyester fiber | 100% |
| Preparative Example 6 | Cotton fiber (C)/polyester fiber (D) | 50%:50% |

Preparative Examples of Woven Fabrics 1 to 21 and 34 to 51

Plain woven fabrics at the blending ratio and the basis weight shown in Table 2 were prepared by using the spun yarns prepared in Preparative

Examples of spun yarns 1 to 5 by a known method.

TABLE 2
Preparative Examples of woven fabrics

| | | Ratio of fibers (wt %) | | | | | |
|---|---|---|---|---|---|---|---|
| Preparative | Preparative | Halogen- | | | | | |
| Example | Example | containing | Silicic | Flame-retardant | | | Basis |
| number of | number of spun | fiber | acid-containing | rayon | Cotton | Polyester | weight |
| woven fabric | yarn used | (A) | rayon(B) | fiber(B) | fiber (C) | fiber (D) | (g/m²) |
| Preparative | Preparative | 10 | 15 | | 75 | | 106 |
| Example 1 | Example 1, 2, 4 | | | | | | |
| Preparative | Preparative | 10 | | 15 | 75 | | 106 |
| Example 2 | Example 1, 3, 4 | | | | | | |
| Preparative | Preparative | 20 | 5 | | 75 | | 110 |
| Example 3 | Example 1, 2, 4 | | | | | | |
| Preparative | Preparative | 60 | 30 | | 10 | | 95 |
| Example 4 | Example 1, 2, 4 | | | | | | |
| Preparative | Preparative | 5 | 45 | | | 50 | 104 |
| Example 5 | Example 1, 2, 5 | | | | | | |
| Preparative | Preparative | 45 | 5 | | | 50 | 104 |
| Example 6 | Example 1, 2, 5 | | | | | | |
| Preparative | Preparative | 45 | | 5 | | 50 | 104 |
| Example 7 | Example 1, 3, 5 | | | | | | |
| Preparative | Preparative | 60 | 30 | | | 10 | 99 |
| Example 8 | Example 1, 2, 5 | | | | | | |
| Preparative | Preparative | 5 | 5 | | 75 | 15 | 104 |
| Example 9 | Example 1, 2, 4, 5 | | | | | | |
| Preparative | Preparative | 5 | | 5 | 75 | 15 | 104 |
| Example 10 | Example 1, 3, 4, 5 | | | | | | |
| Preparative | Preparative | 5 | 5 | | 40 | 50 | 98 |
| Example 11 | Example 1, 2, 4, 5 | | | | | | |
| Preparative | Preparative | 15 | 15 | | 40 | 30 | 80 |
| Example 12 | Example 1, 2, 4, 5 | | | | | | |
| Preparative | Preparative | 20 | 5 | | 75 | | 101 |
| Example 13 | Example 1, 2, 4 | | | | | | |
| Preparative | Preparative | 20 | | 5 | 75 | | 101 |
| Example 14 | Example 1, 3, 4 | | | | | | |
| Preparative | Preparative | 30 | 60 | | 10 | | 109 |
| Example 15 | Example 1, 2, 4 | | | | | | |
| Preparative | Preparative | 60 | 30 | | 10 | | 109 |
| Example 16 | Example 1, 2, 4 | | | | | | |
| Preparative | Preparative | 30 | 60 | | | 10 | 109 |
| Example 17 | Example 1, 2, 5 | | | | | | |
| Preparative | Preparative | 30 | | 60 | | 10 | 109 |
| Example 18 | Example 1, 3, 5 | | | | | | |
| Preparative | Preparative | 60 | 30 | | | 10 | 109 |
| Example 19 | Example 1, 2, 5 | | | | | | |
| Preparative | Preparative | 5 | 5 | | 40 | 50 | 102 |
| Example 20 | Example 1, 2, 4, 5 | | | | | | |
| Preparative | Preparative | 15 | 15 | | 40 | 30 | 106 |
| Example 21 | Example 1, 2, 4, 5 | | | | | | |
| Preparative | Preparative | 20 | | | 80 | | 104 |
| Example 34 | Example 1, 4 | | | | | | |
| Preparative | Preparative | 35 | | | 65 | | 108 |
| Example 35 | Example 1, 4 | | | | | | |
| Preparative | Preparative | | 20 | | 80 | | 104 |
| Example 36 | Example 2, 4 | | | | | | |
| Preparative | Preparative | | 35 | | 65 | | 108 |
| Example 37 | Example 2, 4 | | | | | | |
| Preparative | Preparative | 40 | | | | 60 | 104 |
| Example 38 | Example 1, 5 | | | | | | |
| Preparative | Preparative | 50 | | | | 50 | 103 |
| Example 39 | Example 1, 5 | | | | | | |
| Preparative | Preparative | | 40 | | | 60 | 104 |
| Example 40 | Example 2, 5 | | | | | | |
| Preparative | Preparative | | 50 | | | 50 | 103 |
| Example 41 | Example 2, 5 | | | | | | |
| Preparative | Preparative | 5 | 5 | | 80 | 10 | 90 |
| Example 42 | Example 1, 2, 4, 5 | | | | | | |
| Preparative | Preparative | | 10 | | 75 | 15 | 104 |
| Example 43 | Example 2, 4, 5 | | | | | | |
| Preparative | Preparative | 10 | | | 75 | 15 | 104 |
| Example 44 | Example 1, 4, 5 | | | | | | |
| Preparative | Preparative | 5 | 5 | | 35 | 55 | 101 |
| Example 45 | Example 1, 2, 4, 5 | | | | | | |
| Preparative | Preparative | | 10 | | 40 | 50 | 103 |
| Example 46 | Example 2, 4, 5 | | | | | | |
| Preparative | Preparative | 10 | | | 40 | 50 | 103 |
| Example 47 | Example 1, 4, 5 | | | | | | |
| Preparative | Preparative | 5 | 5 | | 80 | 10 | 108 |
| Example 48 | Example 1, 2, 4, 5 | | | | | | |
| Preparative | Preparative | 5 | 5 | | 35 | 55 | 106 |
| Example 49 | Example 1, 2, 4, 5 | | | | | | |
| Preparative | Preparative | | 10 | | 40 | 50 | 106 |
| Example 50 | Example 2, 4, 5 | | | | | | |
| Preparative | Preparative | 10 | | | 40 | 50 | 106 |
| Example 51 | Example 1, 4, 5 | | | | | | |

Preparative Examples of Nonwoven Fabrics 22 to 33 and 52 to 65

Nonwoven fabrics at the blending ratio and the basis weight shown in Table 3 were prepared by carding the spun yarns prepared in Preparative Examples of spun yarns 1 to 5 into webs in a carding machine.

[Table 3]

TABLE 3
Preparative Example of nonwoven fabric

| | Preparative | | | | | | |
|---|---|---|---|---|---|---|---|
| | Example | | | | | | |
| Preparative | number of | | | | | | |
| Example | spun yarn | Ratio of fibers (wt %) | | | | | |
| number of | used in | | Silicic | | Cotton | | Basis |
| nonwoven | surface | Halogen-containing | acid-containing | Flame-retardant | fiber | Polyester | weight |
| fabric | fabric | fiber (A) | rayon (B) | rayon fiber (B) | (C) | fiber (D) | (g/m²) |
| Preparative | Preparative | 10 | 15 | | 75 | | 142 |
| Example 22 | Example 6 | | | | | | |
| Preparative | Preparative | 10 | | 15 | 75 | | 142 |
| Example 23 | Example 6 | | | | | | |
| Preparative | Preparative | 20 | 5 | | 75 | | 138 |
| Example 24 | Example 6 | | | | | | |
| Preparative | Preparative | 60 | 30 | | 10 | | 141 |
| Example 25 | Example 6 | | | | | | |
| Preparative | Preparative | 5 | 45 | | | 50 | 140 |
| Example 26 | Example 6 | | | | | | |
| Preparative | Preparative | 45 | 5 | | | 50 | 143 |
| Example 27 | Example 6 | | | | | | |
| Preparative | Preparative | 45 | | 5 | | 50 | 143 |
| Example 28 | Example 6 | | | | | | |
| Preparative | Preparative | 60 | 30 | | | 10 | 141 |
| Example 29 | Example 6 | | | | | | |
| Preparative | Preparative | 5 | 5 | | 75 | 15 | 142 |
| Example 30 | Example 6 | | | | | | |
| Preparative | Preparative | 5 | | 5 | 75 | 15 | 142 |
| Example 31 | Example 6 | | | | | | |
| Preparative | Preparative | 5 | 5 | | 40 | 50 | 143 |
| Example 32 | Example 6 | | | | | | |
| Preparative | Preparative | 15 | 15 | | 40 | 30 | 140 |
| Example 33 | Example 6 | | | | | | |
| Preparative | Preparative | 20 | | | 80 | | 140 |
| Example 52 | Example 6 | | | | | | |
| Preparative | Preparative | 35 | | | 65 | | 143 |
| Example 53 | Example 6 | | | | | | |
| Preparative | Preparative | | 20 | | 80 | | 140 |
| Example 54 | Example 6 | | | | | | |
| Preparative | Preparative | | 35 | | 65 | | 139 |
| Example 55 | Example 6 | | | | | | |
| Preparative | Preparative | 40 | | | | 60 | 141 |
| Example 56 | Example 6 | | | | | | |
| Preparative | Preparative | 50 | | | | 50 | 141 |
| Example 57 | Example 6 | | | | | | |
| Preparative | Preparative | | 40 | | | 60 | 146 |
| Example 58 | Example 6 | | | | | | |
| Preparative | Preparative | | 50 | | | 50 | 143 |
| Example 59 | Example 6 | | | | | | |
| Preparative | Preparative | 5 | 5 | | 80 | 10 | 140 |
| Example 60 | Example 6 | | | | | | |
| Preparative | Preparative | | 10 | | 75 | 15 | 143 |
| Example 61 | Example 6 | | | | | | |
| Preparative | Preparative | 10 | | | 75 | 15 | 143 |
| Example 62 | Example 6 | | | | | | |
| Preparative | Preparative | 5 | 5 | | 35 | 55 | 145 |
| Example 63 | Example 6 | | | | | | |
| Preparative | Preparative | | 10 | | 40 | 50 | 148 |
| Example 64 | Example 6 | | | | | | |
| Preparative | Preparative | 10 | | | 40 | 50 | 142 |
| Example 65 | Example 6 | | | | | | |

### Examples 1 to 12

### Section 1, Filling Material: Polyester

A cushion for flame-resistance evaluation was prepared by using each of the plain woven fabrics prepared Preparative Examples of woven fabrics 1 to 12 (flame-shielding fabrics) as the surface fabric according to the method of preparing a cushion for flame-resistance evaluation (1), and the flame resistance thereof was evaluated. Results are summarized in Table 4.

TABLE 4
(Section 1, filling material: polyester)

| | | Fiber blending ratio in | | | | | Structure of surface | |
|---|---|---|---|---|---|---|---|---|
| | Preparative | surface fabric (wt %) | | | | | fabric | |
| | Example | | Silicic | | | | Amount of flame | |
| | number of | Halogen- | acid- | | | | retardant in | |
| Example | woven | containing | containing | Flame-retardant | Cotton | Polyester | surface fabric | Basis weight |
| number | fabric | fiber (A) | rayon fiber (B) | rayon fiber (B) | fiber (C) | fiber (D) | (wt %) | (g/m²) |
| Example 1 | 1 | 10 | 15 | 0 | 75 | 0 | 5.8 | 106 |
| Example 2 | 2 | 10 | 0 | 15 | 75 | 0 | 3.8 | 106 |
| Example 3 | 3 | 20 | 5 | 0 | 75 | 0 | 4.1 | 110 |
| Example 4 | 4 | 60 | 30 | 0 | 10 | 0 | 16.8 | 95 |
| Example 5 | 5 | 5 | 45 | 0 | 0 | 50 | 14.2 | 104 |
| Example 6 | 6 | 45 | 5 | 0 | 0 | 50 | 7.4 | 104 |
| Example 7 | 7 | 45 | 0 | 5 | 0 | 50 | 6.7 | 104 |
| Example 8 | 8 | 60 | 30 | 0 | 0 | 10 | 16.8 | 99 |
| Example 9 | 9 | 5 | 5 | 0 | 75 | 15 | 3.3 | 104 |
| Example 10 | 10 | 5 | 0 | 5 | 75 | 15 | 1.5 | 104 |
| Example 11 | 11 | 5 | 5 | 0 | 40 | 50 | 3.3 | 98 |
| Example 12 | 12 | 15 | 15 | 0 | 30 | 30 | 6.5 | 80 |
| Comparative | 34 | 20 | 0 | 0 | 80 | 0 | 2.6 | 104 |
| Example 1 | | | | | | | | |
| Comparative | 35 | 35 | 0 | 0 | 65 | 0 | 4.6 | 108 |
| Example 2 | | | | | | | | |
| Comparative | 36 | 0 | 20 | 0 | 80 | 0 | 6.0 | 104 |
| Example 3 | | | | | | | | |
| Comparative | 37 | 0 | 35 | 0 | 65 | 0 | 10.5 | 108 |
| Example 4 | | | | | | | | |
| Comparative | 38 | 40 | 0 | 0 | 0 | 60 | 5.2 | 104 |
| Example 5 | | | | | | | | |
| Comparative | 39 | 50 | 0 | 0 | 0 | 50 | 6.5 | 103 |
| Example 6 | | | | | | | | |
| Comparative | 40 | 0 | 40 | 0 | 0 | 60 | 12.0 | 104 |
| Example 7 | | | | | | | | |
| Comparative | 41 | 0 | 50 | 0 | 0 | 50 | 15.0 | 103 |
| Example 8 | | | | | | | | |
| Comparative | 42 | 5 | 5 | 0 | 80 | 10 | 2.2 | 90 |
| Example 9 | | | | | | | | |
| Comparative | 43 | 0 | 10 | 0 | 75 | 15 | 3.0 | 104 |
| Example 10 | | | | | | | | |
| Comparative | 44 | 10 | 0 | 0 | 75 | 15 | 1.3 | 104 |
| Example 11 | | | | | | | | |
| Comparative | 45 | 5 | 5 | 0 | 35 | 55 | 2.2 | 101 |
| Example 12 | | | | | | | | |
| Comparative | 46 | 0 | 10 | 0 | 40 | 50 | 3.0 | 103 |
| Example 13 | | | | | | | | |
| Comparative | 47 | 10 | 0 | 0 | 40 | 50 | 1.3 | 103 |
| Example 14 | | | | | | | | |

| | Sample shape | | | Combustion test | | | | |
|---|---|---|---|---|---|---|---|---|
| | | | Filling material | Weight loss rate | Weight-loss | | | |
| Example | Filling material | Height | quantity/height | after six minutes | termination time | | Appearance of | Overall |
| number | quantity (g) | (inch) | (g/inch) | (%) | (sec) | Rating | carbonized film | rating |
| Example 1 | 47.3 | 4.0 | 11.8 | 1.2 | 80 | ◯ | ◯ | ◯ |
| Example 2 | 50.5 | 4.1 | 12.3 | 3.3 | 85 | ◯ | ◯ | ◯ |
| Example 3 | 48.1 | 3.9 | 12.3 | 1.0 | 70 | ◯ | ◯ | ◯ |
| Example 4 | 40.0 | 3.8 | 10.5 | 0.8 | 25 | ◯ | ◯ | ◯ |
| Example 5 | 42.5 | 3.8 | 11.2 | 16.6 | 185 | ◯ | ◯ | ◯ |
| Example 6 | 46.7 | 3.9 | 12.0 | 21.8 | 170 | ◯ | ◯ | ◯ |
| Example 7 | 48.2 | 3.8 | 12.7 | 19.4 | 160 | ◯ | ◯ | ◯ |
| Example 8 | 50.2 | 4.0 | 12.6 | 1.0 | 30 | ◯ | ◯ | ◯ |
| Example 9 | 39.5 | 3.8 | 10.4 | 10.3 | 185 | ◯ | ◯ | ◯ |
| Example 10 | 43.6 | 4.3 | 10.1 | 15.3 | 215 | ◯ | ◯ | ◯ |
| Example 11 | 49.2 | 4.1 | 12.0 | 20.2 | 190 | ◯ | ◯ | ◯ |
| Example 12 | 47.1 | 4.1 | 11.5 | 19.0 | 180 | ◯ | ◯ | ◯ |
| Comparative | 43.2 | 4.3 | 10.0 | 1.3 | 100 | ◯ | Δ | X |
| Example 1 | | | | | | | | |
| Comparative | 51.3 | 4.1 | 12.5 | 0.5 | 20 | ◯ | Δ | X |
| Example 2 | | | | | | | | |
| Comparative | 39.3 | 4.1 | 9.6 | 18.4 | 395 | Δ | ◯ | X |
| Example 3 | | | | | | | | |
| Comparative | 37.4 | 3.9 | 9.6 | 9.0 | 375 | Δ | ◯ | X |
| Example 4 | | | | | | | | |
| Comparative | 51.0 | 3.8 | 13.4 | 24.5 | 215 | ◯ | Δ | X |
| Example 5 | | | | | | | | |
| Comparative | 49.3 | 3.8 | 13.0 | 21.2 | 185 | ◯ | Δ | X |
| Example 6 | | | | | | | | |
| Comparative | 47.6 | 4.3 | 11.1 | 26.4 | 385 | X | ◯ | X |
| Example 7 | | | | | | | | |
| Comparative | 49.9 | 4.2 | 11.9 | 31.8 | 370 | X | ◯ | X |
| Example 8 | | | | | | | | |
| Comparative | 44.4 | 4.1 | 10.8 | 18.4 | 285 | ◯ | X | X |
| Example 9 | | | | | | | | |
| Comparative | 35.4 | 4.0 | 8.9 | 25.6 | 245 | X | ◯ | X |
| Example 10 | | | | | | | | |
| Comparative | 50.5 | 3.9 | 12.9 | 13.3 | 100 | ◯ | Δ | X |
| Example 11 | | | | | | | | |
| Comparative | 38.7 | 4.1 | 9.4 | 26.9 | 315 | X | X | X |
| Example 12 | | | | | | | | |
| Comparative | 43.3 | 3.8 | 11.4 | 29.1 | 405 | X | X | X |
| Example 13 | | | | | | | | |
| Comparative | 45.8 | 3.8 | 12.1 | 22.8 | 260 | ◯ | X | X |
| Example 14 | | | | | | | | |

### Comparative Examples 1 to 14

### Section 1, Filling Material: Polyester

A cushion for flame-resistance evaluation was prepared by using each of the plain woven fabrics prepared Preparative Examples of woven fabrics 34 to 47 as the surface fabric according to the method of preparing a cushion for flame-resistance evaluation (1) and the flame resistance was evaluated. Results are summarized in Table 4.

The flame resistance and the appearance of the carbonized film in the combustion test were favorable in any one of Examples 1 to 12. Among the cushions of Examples 1 to 12, those containing the cotton fiber (C) were particularly superior in comfortableness such as texture, touch feeling and hygroscopicity, while those containing the polyester fiber (D) were particularly superior in washing resistance and durability.

The cushions of Comparative Examples 1 and 2, which did not contain the flame-retardant cellulosic fiber (B), had a carbonized film unfavorable, compared to those of Examples 1 to 4. The cushions of Comparative Examples 3 and 4, which did not contain the halogen-containing fiber (A), were insufficient in fabric self-extinguishing characteristics and demanded an elongated period until extinguishment. The cushions of Comparative Examples 5 and 6, which contained the halogen-containing fiber (A) in an amount sufficient compared to those of Examples 5 to 8, showed favorable self-extinguishing characteristics, but were unsatisfactory in the appearance of the carbonized film, because they did not contain the flame-retardant cellulosic fiber (B). The cushions of Comparative Examples 7 and 8, which contained the silicic acid-containing fiber (B) sufficiently, had a carbonized film in favorable state, but were insufficient in fabric self-extinguishing characteristics and demanded an elongated period until extinguishment, because they did not contain the halogen-containing fiber (A). The cushion of Comparative Example 9, which contained the cotton fiber (C) at a greater rate than those in Examples 9 and 10, had a carbonized film formed, but it was fragile. The cushion of Comparative Example 10, which contained no halogen-containing fiber (A) in contrast to those of Examples 9 and 10, was lower in fabric self-extinguishing characteristics. The cushion of Comparative Example 11, which contained no flame-retardant cellulosic fiber (B) in contrast to those of Examples 9 and 10, gave a fragile carbonized film. The cushion of Comparative Example 12, which contained the polyester fiber (D) in a greater amount than that of Example 11, was lower in fabric self-extinguishing characteristics. The cushion of Comparative Example 13, which contained no halogen-containing fiber (A) in contrast to that of Example 11, was lower in fabric self-extinguishing characteristics. The cushion of Comparative Example 14, which contained no flame-resistant cellulosic fiber (B) in contrast to that of Example 12, gave a fragile carbonized film.

### Examples 13 to 24

### Section 1, Filling Material: Polyester

According to the method of preparing a cushion for flame-resistance evaluation (1), a cushion for flame-resistance evaluation was prepared by enclosing a filling material with each of the nonwoven fabrics (flame-shielding fabrics) prepared in Preparative Examples of nonwoven fabrics 22 to 33 as the internal fabric, and additionally thereon with a plain-weave fabric (surface fabric) having a basis weight of 120 g/m² prepared with the spun yarn prepared in Preparative Example of spun yarn 6 by a known method, and the flame resistance thereof was evaluated. Results are summarized in Table 5.

TABLE 5
(Section 1, filling material: polyester)

| | Preparative | Fiber blending ratio of | | | | | Structure of | |
|---|---|---|---|---|---|---|---|---|
| | Example | internal fabric (wt %) | | | | | internal fabric | |
| | number of | Halogen- | Silicic | | | | Amount of fire | |
| Example | nonwoven | containing | acid-containing | Flame-retardant | Cotton | Polyester | retardant in internal | Basis |
| number | fabric | fiber (A) | rayon fiber (B) | rayon fiber (B) | fiber (C) | fiber (D) | fabric (wt %) | weight (g/m²) |
| Example 13 | 22 | 10 | 15 | 0 | 75 | 0 | 5.8 | 142 |
| Example 14 | 23 | 10 | 0 | 15 | 75 | 0 | 3.8 | 142 |
| Example 15 | 24 | 20 | 5 | 0 | 75 | 0 | 4.1 | 138 |
| Example 16 | 25 | 60 | 30 | 0 | 10 | 0 | 16.8 | 141 |
| Example 17 | 26 | 5 | 45 | 0 | 0 | 50 | 14.2 | 140 |
| Example 18 | 27 | 45 | 5 | 0 | 0 | 50 | 7.4 | 143 |
| Example 19 | 28 | 45 | 0 | 5 | 0 | 50 | 6.7 | 143 |
| Example 20 | 29 | 60 | 30 | 0 | 0 | 10 | 16.8 | 141 |
| Example 21 | 30 | 5 | 5 | 0 | 75 | 15 | 3.3 | 142 |
| Example 22 | 31 | 5 | 0 | 5 | 75 | 15 | 1.5 | 142 |
| Example 23 | 32 | 5 | 5 | 0 | 40 | 50 | 3.3 | 143 |
| Example 24 | 33 | 15 | 15 | 0 | 40 | 30 | 6.5 | 140 |
| Comparative | 52 | 20 | 0 | 0 | 80 | 0 | 2.6 | 140 |
| Example 15 | | | | | | | | |
| Comparative | 53 | 35 | 0 | 0 | 65 | 0 | 4.6 | 143 |
| Example 16 | | | | | | | | |
| Comparative | 54 | 0 | 20 | 0 | 80 | 0 | 6.0 | 140 |
| Example 17 | | | | | | | | |
| Comparative | 55 | 0 | 35 | 0 | 65 | 0 | 10.5 | 139 |
| Example 18 | | | | | | | | |
| Comparative | 56 | 40 | 0 | 0 | 0 | 60 | 5.2 | 141 |
| Example 19 | | | | | | | | |
| Comparative | 57 | 50 | 0 | 0 | 0 | 50 | 6.5 | 141 |
| Example 20 | | | | | | | | |
| Comparative | 58 | 0 | 40 | 0 | 0 | 60 | 12.0 | 146 |
| Example 21 | | | | | | | | |
| Comparative | 59 | 0 | 50 | 0 | 0 | 50 | 15.0 | 143 |
| Example 22 | | | | | | | | |
| Comparative | 60 | 5 | 5 | 0 | 80 | 10 | 2.2 | 140 |
| Example 23 | | | | | | | | |
| Comparative | 61 | 0 | 10 | 0 | 75 | 15 | 3.0 | 143 |
| Example 24 | | | | | | | | |
| Comparative | 62 | 10 | 0 | 0 | 75 | 15 | 1.3 | 143 |
| Example 25 | | | | | | | | |
| Comparative | 63 | 5 | 5 | 0 | 35 | 55 | 2.2 | 145 |
| Example 26 | | | | | | | | |
| Comparative | 64 | 0 | 10 | 0 | 40 | 50 | 3.0 | 148 |
| Example 27 | | | | | | | | |
| Comparative | 65 | 10 | 0 | 0 | 40 | 50 | 1.3 | 142 |
| Example 28 | | | | | | | | |

| | Sample shape | | | Combustion test | | | | |
|---|---|---|---|---|---|---|---|---|
| | | | Filling material | | Weight-loss | | Appearance of | |
| Example | Filling material | Height | quantity/height | Weight loss rate | termination time | | carbonized | Overall |
| number | quantity (g) | (inch) | (g/inch) | after six minutes (%) | (sec) | Rating | film | rating |
| Example 13 | 25.5 | 4.1 | 6.2 | 0.8 | 60 | ◯ | ◯ | ◯ |
| Example 14 | 23.2 | 4.2 | 5.5 | 3.8 | 70 | ◯ | ◯ | ◯ |
| Example 15 | 29.8 | 4.0 | 7.5 | 1.0 | 90 | ◯ | ◯ | ◯ |
| Example 16 | 24.1 | 3.9 | 6.2 | 1.5 | 70 | ◯ | ◯ | ◯ |
| Example 17 | 24.7 | 4.2 | 5.9 | 14.6 | 235 | ◯ | ◯ | ◯ |
| Example 18 | 30.2 | 3.8 | 7.9 | 15.1 | 200 | ◯ | ◯ | ◯ |
| Example 19 | 26.1 | 3.9 | 6.7 | 18.6 | 210 | ◯ | ◯ | ◯ |
| Example 20 | 28.4 | 4.3 | 6.6 | 2.5 | 25 | ◯ | ◯ | ◯ |
| Example 21 | 22.5 | 4.1 | 5.5 | 3.5 | 195 | ◯ | ◯ | ◯ |
| Example 22 | 24.6 | 3.9 | 6.3 | 5.8 | 200 | ◯ | ◯ | ◯ |
| Example 23 | 29.5 | 4.0 | 7.4 | 19.6 | 285 | ◯ | ◯ | ◯ |
| Example 24 | 25.1 | 3.8 | 6.6 | 14.6 | 155 | ◯ | ◯ | ◯ |
| Comparative | 22.9 | 4.1 | 5.6 | 1.0 | 90 | ◯ | Δ | X |
| Example 15 | | | | | | | | |
| Comparative | 24.1 | 3.9 | 6.2 | 0.1 | 20 | ◯ | Δ | X |
| Example 16 | | | | | | | | |
| Comparative | 26.3 | 4.3 | 6.1 | 21.0 | 365 | Δ | ◯ | X |
| Example 17 | | | | | | | | |
| Comparative | 23.3 | 4.1 | 5.7 | 10.9 | 380 | Δ | ◯ | X |
| Example 18 | | | | | | | | |
| Comparative | 27.1 | 4.2 | 6.5 | 15.8 | 225 | ◯ | Δ | X |
| Example 19 | | | | | | | | |
| Comparative | 25.3 | 4.1 | 6.2 | 15.2 | 195 | ◯ | Δ | X |
| Example 20 | | | | | | | | |
| Comparative | 29.2 | 4.4 | 6.6 | 23.4 | 380 | Δ | ◯ | X |
| Example 21 | | | | | | | | |
| Comparative | 23.7 | 4.0 | 5.9 | 21.8 | 300 | Δ | ◯ | X |
| Example 22 | | | | | | | | |
| Comparative | 30.2 | 4.1 | 7.4 | 21.2 | 255 | ◯ | Δ | X |
| Example 23 | | | | | | | | |
| Comparative | 31.0 | 4.5 | 6.9 | 25.2 | 265 | X | ◯ | X |
| Example 24 | | | | | | | | |
| Comparative | 24.5 | 3.8 | 5.8 | 14.7 | 135 | ◯ | Δ | X |
| Example 25 | | | | | | | | |
| Comparative | 23.9 | 4.2 | 5.7 | 32.4 | 345 | X | X | X |
| Example 26 | | | | | | | | |
| Comparative | 21.6 | 4.1 | 5.2 | 33.5 | 420 | X | Δ | X |
| Example 27 | | | | | | | | |
| Comparative | 23.1 | 4.1 | 5.6 | 26.9 | 380 | X | X | X |
| Example 28 | | | | | | | | |

### Comparative Examples 15 to 28

### Section 1, Filling Material: Polyester

According to the method of preparing a cushion for flame-resistance evaluation (1), a cushion for flame-resistance evaluation was prepared by enclosing a filling material with each of the nonwoven fabrics prepared in Preparative Examples of nonwoven fabrics 52 to 65 as the internal fabric, and additionally thereon with a plain-weave fabric (surface fabric) having a thickness of 120 g/m² prepared with a the spun yarn prepared in Preparative Example of spun yarn 6 by a known method, and the flame resistance thereof was evaluated. Results are summarized in Table 5.

The flame resistance and the appearance of the carbonized film in the combustion test were favorable in any one of Examples 13 to 24. Among the cushions of Examples 13 to 24, those containing the cotton fiber (C) were particularly superior in comfortableness such as texture, touch feeling, and hygroscopicity, while those containing the polyester fiber (D) were particularly superior in washing resistance and durability.

The cushions of Comparative Examples 15 and 16, which did not contain the flame-retardant cellulosic fiber (B), had a carbonized film unfavorable, compared to those of Examples 13 to 16. The cushions of Comparative Examples 17 and 18, which did not contain the halogen-containing fiber (A), were insufficient in fabric self-extinguishing characteristics and demanded an elongated period until extinguishment. The cushions of Comparative Examples 19 and 20, which contained the halogen-containing fiber (A) in an amount sufficient, compared to those of Examples 17 to 20, showed favorable self-extinguishing characteristics, but were unsatisfactory in the appearance of the carbonized film, because they did not contain the flame-retardant cellulosic fiber (B). The cushions of Comparative Examples 21 and 22, which contained the silicic acid-containing fiber (B) sufficiently, had a carbonized film in favorable state, but were insufficient in fabric self-extinguishing characteristics and demanded an elongated period until extinguishment because they did not contain the halogen-containing fiber (A). The cushion of Comparative Example 23, which contained the cotton fiber (C) at a greater rate than those in Examples 21 and 22, had a carbonized film formed but fragile. The cushion of Comparative Example 24, which contained no halogen-containing fiber (A) in contrast to those of Examples 21 and 22, was lower in fabric self-extinguishing characteristics. The cushion of Comparative Example 25, which contained no flame-retardant cellulosic fiber (B) in contrast to those of Examples 21 and 22, gave a fragile carbonized film. The cushion of Comparative Example 26, which contained the polyester fiber (D) in a greater amount than that of Example 23, was lower in fabric self-extinguishing characteristics. The cushion of Comparative Example 27, which contained no halogen-containing fiber (A) in contrast to that of Example 23, was lower in fabric self-extinguishing characteristics. The cushion of Comparative Example 28, which contained no flame-resistant cellulosic fiber (B) in contrast to that of Example 24, gave a fragile carbonized film.

### Examples 25 to 36

### Section 2, Filling Material: Polyester

A cushion for flame-resistance evaluation was prepared by using each of the plain woven fabrics prepared in Preparative Examples of woven fabrics 1 to 12 (flame-shielding fabrics) as the surface fabric according to the method of preparing a cushion for flame-resistance evaluation (2) and the flame resistance thereof was evaluated. Results are summarized in Table 6.

TABLE 6
(Section 2, filling material: polyester)

| | Preparative | Fiber blending ratio in | | | | | Structure of surface | |
|---|---|---|---|---|---|---|---|---|
| | Example | surface fabric (wt %) | | | | | fabric | |
| | number of | Halogen- | Silicic acid- | Flame- | | | Amount of flame | |
| Example | woven | containing | containing | retardant rayon | Cotton | Polyester | retardant in surface | Basis |
| number | fabric | fiber (A) | rayon fiber (B) | fiber (B) | fiber (C) | fiber (D) | fabric (wt %)) | weight (g/m²) |
| Example 25 | 1 | 10 | 15 | 0 | 75 | 0 | 5.8 | 106 |
| Example 26 | 2 | 10 | 0 | 15 | 75 | 0 | 3.8 | 106 |
| Example 27 | 3 | 20 | 5 | 0 | 75 | 0 | 4.1 | 110 |
| Example 28 | 4 | 60 | 30 | 0 | 10 | 0 | 16.8 | 95 |
| Example 29 | 5 | 5 | 45 | 0 | 0 | 50 | 14.2 | 104 |
| Example 30 | 6 | 45 | 5 | 0 | 0 | 50 | 7.4 | 104 |
| Example 31 | 7 | 45 | 0 | 5 | 0 | 50 | 6.7 | 104 |
| Example 32 | 8 | 60 | 30 | 0 | 0 | 10 | 16.8 | 99 |
| Example 33 | 9 | 5 | 5 | 0 | 75 | 15 | 3.3 | 104 |
| Example 34 | 10 | 5 | 0 | 5 | 75 | 15 | 1.5 | 104 |
| Example 35 | 11 | 5 | 5 | 0 | 40 | 50 | 3.3 | 98 |
| Example 36 | 12 | 15 | 15 | 0 | 30 | 30 | 6.5 | 80 |
| Comparative | 34 | 20 | 0 | 0 | 80 | 0 | 2.6 | 104 |
| Example 29 | | | | | | | | |
| Comparative | 35 | 35 | 0 | 0 | 65 | 0 | 4.6 | 108 |
| Example 30 | | | | | | | | |
| Comparative | 36 | 0 | 20 | 0 | 80 | 0 | 6.0 | 104 |
| Example 31 | | | | | | | | |
| Comparative | 37 | 0 | 35 | 0 | 65 | 0 | 10.5 | 108 |
| Example 32 | | | | | | | | |
| Comparative | 38 | 40 | 0 | 0 | 0 | 60 | 5.2 | 104 |
| Example 33 | | | | | | | | |
| Comparative | 39 | 50 | 0 | 0 | 0 | 50 | 6.5 | 103 |
| Example 34 | | | | | | | | |
| Comparative | 40 | 0 | 40 | 0 | 0 | 60 | 12.0 | 104 |
| Example 35 | | | | | | | | |
| Comparative | 41 | 0 | 50 | 0 | 0 | 50 | 15.0 | 103 |
| Example 36 | | | | | | | | |
| Comparative | 42 | 5 | 5 | 0 | 80 | 10 | 2.2 | 90 |
| Example 37 | | | | | | | | |
| Comparative | 43 | 0 | 10 | 0 | 75 | 15 | 3.0 | 104 |
| Example 38 | | | | | | | | |
| Comparative | 44 | 10 | 0 | 0 | 75 | 15 | 1.3 | 104 |
| Example 39 | | | | | | | | |
| Comparative | 45 | 5 | 5 | 0 | 35 | 55 | 2.2 | 101 |
| Example 40 | | | | | | | | |
| Comparative | 46 | 0 | 10 | 0 | 40 | 50 | 3.0 | 103 |
| Example 41 | | | | | | | | |
| Comparative | 47 | 10 | 0 | 0 | 40 | 50 | 1.3 | 103 |
| Example 42 | | | | | | | | |

| | Sample shape | | | Combustion test | | | | |
|---|---|---|---|---|---|---|---|---|
| | | | Filling material | Weight loss | Weight-loss | | | |
| Example | Filling material | | quantity/height | rate after | termination | | Appearance | Overall |
| number | quantity (g) | Height (inch) | (g/inch) | six minutes (%) | time (sec) | Rating | of carbonized film | rating |
| Example 25 | 52.3 | 4.2 | 12.5 | 1.0 | 65 | ◯ | ◯ | ◯ |
| Example 26 | 49.3 | 4.3 | 11.5 | 3.7 | 85 | ◯ | ◯ | ◯ |
| Example 27 | 50.2 | 3.7 | 13.6 | 1.2 | 80 | ◯ | ◯ | ◯ |
| Example 28 | 47.2 | 4.0 | 11.8 | 0.6 | 25 | ◯ | ◯ | ◯ |
| Example 29 | 45.1 | 3.9 | 11.6 | 15.7 | 215 | ◯ | ◯ | ◯ |
| Example 30 | 42.1 | 4.1 | 10.3 | 16.8 | 195 | ◯ | ◯ | ◯ |
| Example 31 | 48.3 | 4.3 | 11.2 | 19.9 | 205 | ◯ | ◯ | ◯ |
| Example 32 | 41.8 | 3.8 | 11.0 | 0.8 | 25 | ◯ | ◯ | ◯ |
| Example 33 | 50.1 | 4.3 | 11.7 | 4.2 | 205 | ◯ | ◯ | ◯ |
| Example 34 | 42.9 | 3.9 | 11.0 | 5.2 | 225 | ◯ | ◯ | ◯ |
| Example 35 | 43.3 | 4.0 | 10.8 | 19.4 | 290 | ◯ | ◯ | ◯ |
| Example 36 | 51.2 | 4.2 | 12.2 | 13.2 | 155 | ◯ | ◯ | ◯ |
| Comparative | 48.4 | 4.2 | 11.5 | 0.9 | 90 | ◯ | Δ | X |
| Example 29 | | | | | | | | |
| Comparative | 47.1 | 4.0 | 11.8 | 0.2 | 20 | ◯ | Δ | X |
| Example 30 | | | | | | | | |
| Comparative | 42.6 | 3.9 | 10.9 | 20.4 | 365 | X | ◯ | X |
| Example 31 | | | | | | | | |
| Comparative | 45.3 | 4.1 | 11.0 | 11.6 | 385 | Δ | ◯ | X |
| Example 32 | | | | | | | | |
| Comparative | 49.1 | 3.7 | 13.3 | 16.5 | 235 | ◯ | Δ | X |
| Example 33 | | | | | | | | |
| Comparative | 46.3 | 3.9 | 11.9 | 15.2 | 185 | ◯ | Δ | X |
| Example 34 | | | | | | | | |
| Comparative | 47.9 | 4.3 | 11.1 | 23.9 | 395 | X | ◯ | X |
| Example 35 | | | | | | | | |
| Comparative | 50.3 | 4.2 | 12.0 | 21.8 | 310 | X | ◯ | X |
| Example 36 | | | | | | | | |
| Comparative | 45.2 | 3.8 | 11.9 | 19.4 | 245 | ◯ | X | X |
| Example 37 | | | | | | | | |
| Comparative | 47.3 | 4.1 | 11.5 | 25.3 | 275 | X | ◯ | X |
| Example 38 | | | | | | | | |
| Comparative | 50.1 | 4.0 | 12.2 | 14.3 | 125 | ◯ | Δ | X |
| Example 39 | | | | | | | | |
| Comparative | 44.8 | 4.1 | 10.9 | 28.9 | 335 | X | X | X |
| Example 40 | | | | | | | | |
| Comparative | 43.5 | 4.2 | 10.4 | 30.1 | 425 | X | X | X |
| Example 41 | | | | | | | | |
| Comparative | 46.2 | 3.9 | 11.8 | 18.8 | 310 | ◯ | X | X |
| Example 42 | | | | | | | | |

### Comparative Examples 29 to 42

### Section 2, Filling Material: Polyester

A cushion for flame-resistance evaluation was prepared by using each of the plain woven fabrics prepared in Preparative Examples of woven fabrics 34 to 47 as the surface fabric according to the method of preparing a cushion for flame-resistance evaluation (2) and the flame resistance thereof was evaluated. Results are summarized in Table 6.

The flame resistance and the appearance of the carbonized film in the combustion test were favorable in any one of Examples 25 to 36. Among the cushions of Examples 25 to 36, those containing the cotton fiber (C) were particularly superior in comfortableness such as texture, touch feeling, and hygroscopicity, while those containing the polyester fiber (D) were particularly superior in washing resistance and durability.

The cushions of Comparative Examples 29 and 30, which did not contain the flame-retardant cellulosic fiber (B), had a carbonized film unfavorable, compared to those of Examples 25 to 28. The cushions of Comparative Examples 31 and 32, which did not contain the halogen-containing fiber (A), were insufficient in fabric self-extinguishing characteristics and demanded an elongated period until extinguishment. The cushions of Comparative Examples 33 and 34, which contained the halogen-containing fiber (A) in an amount sufficient compared to those of Examples 29 to 32, showed favorable self-extinguishing characteristics, but were unsatisfactory in the appearance of the carbonized film, because they did not contain the flame-retardant cellulosic fiber (B). The cushions of Comparative Examples 35 and 36, which contained the silicic acid-containing fiber (B) sufficiently, had a carbonized film in favorable state, but were insufficient in fabric self-extinguishing characteristics and demanded an elongated period until extinguishment, because they did not contain the halogen-containing fiber (A). The cushion of Comparative Example 37, which contained the cotton fiber (C) at a greater rate than those in Examples 33 and 34, had a carbonized film formed but fragile. The cushion of Comparative Example 38, which contained no halogen-containing fiber (A) in contrast to those of Examples 33 and 34, was lower in fabric self-extinguishing characteristics. The cushion of Comparative Example 39, which contained no flame-retardant cellulosic fiber (B) in contrast to those of Examples 33 and 34, gave a fragile carbonized film. The cushion of Comparative Example 40, which contained the polyester fiber (D) in a greater amount than that of Example 35, was lower in fabric self-extinguishing characteristics. The cushion of Comparative Example 41, which contained no halogen-containing fiber (A) in contrast to that of Example 35, was lower in fabric self-extinguishing characteristics. The cushion of Comparative Example 42, which contained no flame-resistant cellulosic fiber (B) in contrast to that of Example 36, gave a fragile carbonized film.

### Examples 37 to 48

### Section 2, Filling Material: Polyester

According to the method of preparing a cushion for flame-resistance evaluation (2), a cushion for flame-resistance evaluation was prepared by enclosing a filling material with each of the nonwoven fabrics (flame-shielding fabrics) prepared in Preparative Examples of nonwoven fabrics 22 to 33 as the internal fabric, and additionally thereon with a plain-weave fabric (surface fabric) having a basis weight of 120 g/m² prepared with a the spun yarn prepared in Preparative Example of spun yarn 6 by a known method, and the flame resistance thereof was evaluated. Results are summarized in Table 7.

TABLE 7
(Section 2, filling material: polyester)

| | Preparative | Fiber blending ratio | | | | | Structure of | |
|---|---|---|---|---|---|---|---|---|
| | Example | of internal fabric (wt %) | | | | | internal fabric | |
| | number of | Halogen- | Silicic acid- | Flame- | | | Amount of fire | |
| Example | nonwoven | containing | containing | retardant rayon | Cotton | Polyester | retardant in internal | Basis |
| number | fabric | fiber (A) | rayon fiber (B) | fiber (B) | fiber (C) | fiber (D) | fabric (wt %) | weight (g/m²) |
| Example 37 | 22 | 10 | 15 | 0 | 75 | 0 | 5.8 | 142 |
| Example 38 | 23 | 10 | 0 | 15 | 75 | 0 | 3.8 | 142 |
| Example 39 | 24 | 20 | 5 | 0 | 75 | 0 | 4.1 | 138 |
| Example 40 | 25 | 60 | 30 | 0 | 10 | 0 | 16.8 | 141 |
| Example 41 | 26 | 5 | 45 | 0 | 0 | 50 | 14.2 | 140 |
| Example 42 | 27 | 45 | 5 | 0 | 0 | 50 | 7.4 | 143 |
| Example 43 | 28 | 45 | 0 | 5 | 0 | 50 | 6.7 | 143 |
| Example 44 | 29 | 60 | 30 | 0 | 0 | 10 | 16.8 | 141 |
| Example 45 | 30 | 5 | 5 | 0 | 75 | 15 | 3.3 | 142 |
| Example 46 | 31 | 5 | 0 | 5 | 75 | 15 | 1.5 | 142 |
| Example 47 | 32 | 5 | 5 | 0 | 40 | 50 | 3.3 | 143 |
| Example 48 | 33 | 15 | 15 | 0 | 30 | 30 | 6.5 | 140 |
| Comparative | 52 | 20 | 0 | 0 | 80 | 0 | 2.6 | 140 |
| Example 43 | | | | | | | | |
| Comparative | 53 | 35 | 0 | 0 | 65 | 0 | 4.6 | 143 |
| Example 44 | | | | | | | | |
| Comparative | 54 | 0 | 20 | 0 | 80 | 0 | 6.0 | 140 |
| Example 45 | | | | | | | | |
| Comparative | 55 | 0 | 35 | 0 | 65 | 0 | 10.5 | 139 |
| Example 46 | | | | | | | | |
| Comparative | 56 | 40 | 0 | 0 | 0 | 60 | 5.2 | 141 |
| Example 47 | | | | | | | | |
| Comparative | 57 | 50 | 0 | 0 | 0 | 50 | 6.5 | 141 |
| Example 48 | | | | | | | | |
| Comparative | 58 | 0 | 40 | 0 | 0 | 60 | 12.0 | 146 |
| Example 49 | | | | | | | | |
| Comparative | 59 | 0 | 50 | 0 | 0 | 50 | 15.0 | 143 |
| Example 50 | | | | | | | | |
| Comparative | 60 | 5 | 5 | 0 | 80 | 10 | 2.2 | 140 |
| Example 51 | | | | | | | | |
| Comparative | 61 | 0 | 10 | 0 | 75 | 15 | 3.0 | 143 |
| Example 52 | | | | | | | | |
| Comparative | 62 | 10 | 0 | 0 | 75 | 15 | 1.3 | 143 |
| Example 53 | | | | | | | | |
| Comparative | 63 | 5 | 5 | 0 | 35 | 55 | 2.2 | 145 |
| Example 54 | | | | | | | | |
| Comparative | 64 | 0 | 10 | 0 | 40 | 50 | 3.0 | 148 |
| Example 55 | | | | | | | | |
| Comparative | 65 | 10 | 0 | 0 | 40 | 50 | 1.3 | 142 |
| Example 56 | | | | | | | | |

| | Sample shape | | | Combustion test | | | | |
|---|---|---|---|---|---|---|---|---|
| | | | Filling material | Weight loss | Weight-loss | | | |
| Example | Filling material | | quantity/ | rate after | termination | | Appearance of | |
| number | quantity (g) | Height (inch) | height (g/inch) | six minutes (%) | time (sec) | Rating | carbonized film | Overall rating |
| Example 37 | 26.3 | 4.2 | 6.3 | 0.8 | 60 | ◯ | ◯ | ◯ |
| Example 38 | 25.2 | 4.0 | 6.3 | 3.8 | 70 | ◯ | ◯ | ◯ |
| Example 39 | 27.0 | 4.0 | 6.8 | 1.0 | 90 | ◯ | ◯ | ◯ |
| Example 40 | 29.1 | 4.3 | 6.8 | 1.5 | 70 | ◯ | ◯ | ◯ |
| Example 41 | 30.2 | 4.5 | 6.7 | 14.6 | 235 | ◯ | ◯ | ◯ |
| Example 42 | 28.3 | 4.1 | 6.9 | 15.1 | 200 | ◯ | ◯ | ◯ |
| Example 43 | 24.9 | 4.0 | 6.2 | 18.6 | 210 | ◯ | ◯ | ◯ |
| Example 44 | 27.6 | 4.2 | 6.6 | 2.5 | 25 | ◯ | ◯ | ◯ |
| Example 45 | 22.6 | 4.1 | 5.5 | 3.5 | 195 | ◯ | ◯ | ◯ |
| Example 46 | 23.9 | 4.0 | 6.0 | 5.8 | 200 | ◯ | ◯ | ◯ |
| Example 47 | 24.1 | 4.2 | 5.7 | 19.6 | 285 | ◯ | ◯ | ◯ |
| Example 48 | 24.0 | 4.4 | 5.5 | 14.6 | 155 | ◯ | ◯ | ◯ |
| Comparative | 30.9 | 4.5 | 6.9 | 1.0 | 90 | ◯ | Δ | X |
| Example 43 | | | | | | | | |
| Comparative | 26.9 | 3.9 | 6.9 | 0.1 | 20 | ◯ | Δ | X |
| Example 44 | | | | | | | | |
| Comparative | 28.7 | 4.2 | 6.8 | 21.0 | 365 | X | ◯ | X |
| Example 45 | | | | | | | | |
| Comparative | 25.1 | 4.1 | 6.1 | 10.9 | 380 | Δ | ◯ | X |
| Example 46 | | | | | | | | |
| Comparative | 22.9 | 4.1 | 5.9 | 15.8 | 225 | ◯ | Δ | X |
| Example 47 | | | | | | | | |
| Comparative | 23.2 | 4.3 | 5.4 | 15.2 | 195 | ◯ | Δ | X |
| Example 48 | | | | | | | | |
| Comparative | 23.8 | 4.2 | 5.7 | 23.4 | 380 | X | ◯ | X |
| Example 49 | | | | | | | | |
| Comparative | 22.3 | 4.0 | 5.6 | 21.8 | 300 | X | ◯ | X |
| Example 50 | | | | | | | | |
| Comparative | 24.3 | 4.2 | 5.8 | 21.2 | 255 | X | Δ | X |
| Example 51 | | | | | | | | |
| Comparative | 24.7 | 4.4 | 5.6 | 25.2 | 265 | X | ◯ | X |
| Example 52 | | | | | | | | |
| Comparative | 22.1 | 3.9 | 5.7 | 14.7 | 135 | ◯ | Δ | X |
| Example 53 | | | | | | | | |
| Comparative | 26.3 | 4.5 | 5.8 | 32.4 | 345 | X | X | X |
| Example 54 | | | | | | | | |
| Comparative | 23.3 | 4.0 | 5.8 | 33.5 | 420 | X | Δ | X |
| Example 55 | | | | | | | | |
| Comparative | 26.0 | 4.1 | 6.3 | 26.9 | 380 | X | X | X |
| Example 56 | | | | | | | | |

### Comparative Examples 43 to 56

### Section 2, Filling Material: Polyester

According to the method of preparing a cushion for flame-resistance evaluation (2), a cushion for flame-resistance evaluation was prepared by enclosing a filling material with each of the nonwoven fabrics (flame-shielding fabrics) prepared in Preparative Examples of nonwoven fabrics 52 to 65 as the internal fabric, and additionally thereon with a plain-weave fabric (surface fabric) having a basis weight of 120 g/m² prepared with a the spun yarn prepared in Preparative Example of spun yarn 6 by a known method, and the flame resistance thereof was evaluated. Results are summarized in Table 7.

The flame resistance and the appearance of the carbonized film in the combustion test were favorable in any one of Examples 37 to 48. Among the cushions of Examples 37 to 48, those containing the cotton fiber (C) were particularly superior in comfortableness such as texture, touch feeling, and hygroscopicity, while those containing the polyester fiber (D) were particularly superior in washing resistance and durability.

The cushions of Comparative Examples 43 and 44, which did not contain the flame-retardant cellulosic fiber (B), had a carbonized film unfavorable, compared to those of Examples 37 to 40. The cushions of Comparative Examples 45 and 46, which did not contain the halogen-containing fiber (A), were insufficient in fabric self-extinguishing characteristics and demanded an elongated period until extinguishment. The cushions of Comparative Examples 47 and 48, which contained the halogen-containing fiber (A) in an amount sufficient compared to those of Examples 41 to 44, showed favorable self-extinguishing characteristics, but were unsatisfactory in the appearance of the carbonized film, because they did not contain the flame-retardant cellulosic fiber (B). The cushions of Comparative Examples 49 and 50, which contained the silicic acid-containing fiber (B) sufficiently, had a carbonized film in favorable state, but were insufficient in fabric self-extinguishing characteristics and demanded an elongated period until extinguishment because they din not contain the halogen-containing fiber(A). The cushion of Comparative Example 51, which contained the cotton fiber (C) at a greater rate than those in Examples 45 and 46, had a carbonized film formed but fragile. The cushion of Comparative Example 52, which contained no halogen-containing fiber (A) in contrast to those of Examples 45 and 46, was lower in fabric self-extinguishing characteristics. The cushion of Comparative Example 53, which contained no flame-retardant cellulosic fiber (B) in contrast to those of Examples 45 and 46, gave a fragile carbonized film. The cushion of Comparative Example 54, which contained the polyester fiber (D) in a greater amount than that of Example 47, was lower in fabric self-extinguishing characteristics. The cushion of Comparative Example 55, which contained no halogen-containing fiber (A) in contrast to that of Example 47, was lower in fabric self-extinguishing characteristics. The cushion of Comparative Example 56, which contained no flame-resistant cellulosic fiber (B) in contrast to that of Example 48, gave a fragile carbonized film.

### Examples 49 to 54

### Section 1, Filling Material: Feather

According to the method of preparing a cushion for flame-resistance evaluation (3), a cushion for flame-resistance evaluation was prepared by using each of the plain-weave fabrics (flame-shielding fabrics) prepared in Preparative Examples of woven fabrics 1, 2 and 13 to 16 as the surface fabric, and the flame resistance thereof was evaluated. Results are summarized in Table 8.

TABLE 8
(Section 1, filling material: feather)

| | | Fiber blending ratio in | | | | | Structure of | |
|---|---|---|---|---|---|---|---|---|
| | Preparative | surface fabric (wt %) | | | | | surface fabric | |
| | Example | | Silicic | | | | Amount of flame | |
| | number of | Halogen- | acid- | | | | retardant in | |
| Example | woven | containing | containing | Flame-retardant | Cotton | Polyester | surface fabric | Basis |
| number | fabric | fiber (A) | rayon fiber (B) | rayon fiber (B) | fiber (C) | fiber (D) | (wt %)) | weight (g/m²) |
| Example 49 | 1 | 10 | 15 | 0 | 75 | 0 | 5.8 | 106 |
| Example 50 | 2 | 10 | 0 | 15 | 75 | 0 | 3.8 | 106 |
| Example 51 | 13 | 20 | 5 | 0 | 75 | 0 | 4.1 | 101 |
| Example 52 | 14 | 20 | 0 | 5 | 75 | 0 | 3.4 | 101 |
| Example 53 | 15 | 30 | 60 | 0 | 10 | 0 | 21.9 | 109 |
| Example 54 | 16 | 60 | 30 | 0 | 10 | 0 | 16.8 | 109 |
| Comparative | 25 | 20 | 0 | 0 | 80 | 0 | 2.6 | 104 |
| Example 57 | | | | | | | | |
| Comparative | 26 | 35 | 0 | 0 | 65 | 0 | 4.6 | 108 |
| Example 58 | | | | | | | | |
| Comparative | 27 | 0 | 20 | 0 | 80 | 0 | 6.0 | 104 |
| Example 59 | | | | | | | | |
| Comparative | 28 | 0 | 35 | 0 | 65 | 0 | 10.5 | 108 |
| Example 60 | | | | | | | | |

| | Sample shape | | Combustion test | | | | |
|---|---|---|---|---|---|---|---|
| | Feather | | Weight loss rate | Weight-loss | | | |
| | weight | | after six minutes | termination time | | Appearance of | |
| Example number | (g) | Sample height (inch) | (%) | (sec) | Rating | carbonized film | Overall rating |
| Example 49 | 47.3 | 4.0 | 1.0 | 85 | ◯ | ◯ | ◯ |
| Example 50 | 50.5 | 4.1 | 3.5 | 85 | ◯ | ◯ | ◯ |
| Example 51 | 48.1 | 3.9 | 1.0 | 70 | ◯ | ◯ | ◯ |
| Example 52 | 51.0 | 4.0 | 1.0 | 60 | ◯ | ◯ | ◯ |
| Example 53 | 47.3 | 4.0 | 0.5 | 20 | ◯ | ◯ | ◯ |
| Example 54 | 40.0 | 3.8 | 0.5 | 20 | ◯ | ◯ | ◯ |
| Comparative | 43.2 | 4.3 | 1.0 | 85 | ◯ | Δ | X |
| Example 57 | | | | | | | |
| Comparative | 51.3 | 4.1 | 0.5 | 20 | ◯ | Δ | X |
| Example 58 | | | | | | | |
| Comparative | 39.3 | 4.1 | 16.4 | 380 | Δ | ◯ | X |
| Example 59 | | | | | | | |
| Comparative | 37.4 | 3.9 | 7.8 | 365 | Δ | ◯ | X |
| Example 60 | | | | | | | |

### Comparative Examples 57 to 60

### Section 1, Filling Material: Feather

According to the method of preparing a cushion for flame-resistance evaluation (3), a cushion for flame-resistance evaluation was prepared by using each of the plain-weave fabrics prepared in Preparative Examples of woven fabrics 25 to 28 as the surface fabric, and the flame resistance thereof was evaluated. Results are summarized in Table 8.

The flame resistance and the appearance of the carbonized film in the combustion test were favorable in any one of Examples 49 to 54. The cushions of Comparative Examples 57 and 58, which did not contain the flame-retardant cellulosic fiber (B), had a carbonized film unfavorable, compared to those of Examples 49 to 52. The cushions of Comparative Examples 59 and 60, which did not contain the halogen-containing fiber (A), were insufficient in fabric self-extinguishing characteristics and demanded an elongated period until extinguishment, compared to those of Examples 53 and 54. The cushions of Examples 49 to 54, which were highly flame resistant and contained the cotton fiber (C), were particularly superior in comfortableness such as texture, feeling and hygroscopicity.

### Examples 55 to 60

### Section 1, Filling Material: Feather

According to the method of preparing a cushion for flame-resistance evaluation (3), a cushion for flame-resistance evaluation was prepared by using each of the plain-weave fabrics (flame-shielding fabrics) prepared in Preparative Examples of woven fabrics 5 to 7 and 17 to 19 as the surface fabric, and the flame resistance thereof was evaluated. Results are summarized in Table 9.

TABLE 9
(Section 1, filling material: feather)

| | | Fiber blending ratio in | | | | | Structure of | |
|---|---|---|---|---|---|---|---|---|
| | Preparative | surface fabric (wt %) | | | | | surface fabric | |
| | Example | | Silicic | | | | Amount of flame | |
| | number of | Halogen- | acid- | | | | retardant in | |
| Example | woven | containing | containing | Post-processed | Cotton | Polyester | surface fabric | Basis |
| number | fabric | fiber (A) | rayon fiber (B) | rayon fiber (B) | fiber (C) | fiber (D) | (wt %)) | weight (g/m²) |
| Example 55 | 5 | 5 | 45 | 0 | 0 | 50 | 14.2 | 104 |
| Example 56 | 6 | 45 | 5 | 0 | 0 | 50 | 7.4 | 104 |
| Example 57 | 7 | 45 | 0 | 5 | 0 | 50 | 6.7 | 104 |
| Example 58 | 17 | 30 | 60 | 0 | 0 | 10 | 21.9 | 109 |
| Example 59 | 18 | 30 | 0 | 60 | 0 | 10 | 13.9 | 109 |
| Example 60 | 19 | 60 | 30 | 0 | 0 | 10 | 16.8 | 109 |
| Comparative | 29 | 40 | 0 | 0 | 0 | 60 | 5.2 | 104 |
| Example 61 | | | | | | | | |
| Comparative | 30 | 50 | 0 | 0 | 0 | 50 | 6.5 | 103 |
| Example 62 | | | | | | | | |
| Comparative | 31 | 0 | 40 | 0 | 0 | 60 | 12.0 | 104 |
| Example 63 | | | | | | | | |
| Comparative | 32 | 0 | 50 | 0 | 0 | 50 | 15.0 | 103 |
| Example 64 | | | | | | | | |

| | Sample shape | | Combustion test | | | | |
|---|---|---|---|---|---|---|---|
| | Feather | | Weight loss rate | Weight-loss | | | |
| | weight | | after six minutes | termination time | | Appearance of | |
| Example number | (g) | Sample height (inch) | (%) | (sec) | Rating | carbonized film | Overall rating |
| Example 55 | 42.5 | 3.8 | 17.6 | 190 | ◯ | ◯ | ◯ |
| Example 56 | 46.7 | 3.9 | 21.8 | 165 | ◯ | ◯ | ◯ |
| Example 57 | 48.2 | 3.8 | 19.6 | 175 | ◯ | ◯ | ◯ |
| Example 58 | 47.3 | 4.2 | 1.5 | 60 | ◯ | ◯ | ◯ |
| Example 59 | 51.0 | 4.1 | 1.5 | 60 | ◯ | ◯ | ◯ |
| Example 60 | 50.2 | 4.0 | 0.5 | 20 | ◯ | ◯ | ◯ |
| Comparative | 51.0 | 3.8 | 23.5 | 205 | ◯ | Δ | X |
| Example 61 | | | | | | | |
| Comparative | 49.3 | 3.8 | 20.3 | 180 | ◯ | Δ | X |
| Example 62 | | | | | | | |
| Comparative | 47.6 | 4.3 | 26.4 | 370 | X | ◯ | X |
| Example 63 | | | | | | | |
| Comparative | 49.9 | 4.2 | 31.3 | 360 | X | ◯ | X |
| Example 64 | | | | | | | |

### Comparative Examples 61 to 64

### Section 1, Filling Material: Feather

According to the method of preparing a cushion for flame-resistance evaluation (3), a cushion for flame-resistance evaluation was prepared by using each of the plain-weave fabrics prepared in Preparative Examples of woven fabrics 29 to 32 as the surface fabric, and the flame resistance thereof was evaluated. Results are summarized in Table 9.

The flame resistance and the appearance of the carbonized film in the combustion test were favorable in any one of Examples 55 to 60. The cushions of Comparative Examples 61 and 62, which contained the halogen-containing fiber (A) in sufficient amount, had favorable self-extinguishing characteristics, but had a carbonized film in an unfavorable state, because they did not contain the flame-retardant cellulosic fiber (B). The cushions of Comparative Examples 63 and 64, which contained the silicic acid-containing rayon fiber (B) in sufficient amount, had a carbonized film in favorable state, but showed unfavorable fabric self-extinguishing characteristics, because they did not contain the halogen-containing fiber (A). The cushions of Examples 55 to 60, which were highly flame-resistant, had a texture and touch feeling of the fiber favorable as the raw material for flame-shielding fabric, and contained the polyester fiber (D), were particularly superior in washing resistance and durability.

### Examples 61 to 64

### Section 1, Filling Material: Feather

According to the method of preparing a cushion for flame-resistance evaluation (3), a cushion for flame-resistance evaluation was prepared by using each of the plain-weave fabrics (flame-shielding fabrics) prepared in Preparative Examples of woven fabrics 9, 10, 20 and 21 as the surface fabric, and the flame resistance thereof was evaluated. Results are summarized in Table 10.

TABLE 10
(Section 1, filling material: feather)

| | | Fiber blending ratio in | | | | | Structure of surface | |
|---|---|---|---|---|---|---|---|---|
| | Preparative | surface fabric (wt %) | | | | | fabric | |
| | Example | | Silicic | | | | Amount of flame | |
| | number of | Halogen- | acid- | | | | retardant in | |
| Example | woven | containing | containing | Post-processed | Cotton | Polyester | surface fabric | Basis |
| number | fabric | fiber (A) | rayon fiber (B) | rayon fiber (B) | fiber (C) | fiber (D) | (wt %)) | weight (g/m²) |
| Example 61 | 9 | 5 | 5 | 0 | 75 | 15 | 2.2 | 104 |
| Example 62 | 10 | 5 | 0 | 5 | 75 | 15 | 1.5 | 104 |
| Example 63 | 20 | 5 | 5 | 0 | 40 | 50 | 2.2 | 102 |
| Example 64 | 21 | 15 | 15 | 0 | 40 | 30 | 6.5 | 106 |
| Comparative | 48 | 5 | 5 | 0 | 80 | 10 | 2.2 | 108 |
| Example 65 | | | | | | | | |
| Comparative | 34 | 0 | 10 | 0 | 75 | 15 | 3.0 | 104 |
| Example 66 | | | | | | | | |
| Comparative | 35 | 10 | 0 | 0 | 75 | 15 | 1.3 | 104 |
| Example 67 | | | | | | | | |
| Comparative | 49 | 5 | 5 | 0 | 35 | 55 | 2.2 | 106 |
| Example 68 | | | | | | | | |
| Comparative | 50 | 0 | 10 | 0 | 40 | 50 | 3.0 | 106 |
| Example 69 | | | | | | | | |
| Comparative | 51 | 10 | 0 | 0 | 40 | 50 | 1.3 | 106 |
| Example 70 | | | | | | | | |

| | Sample shape | | Combustion test | | | | |
|---|---|---|---|---|---|---|---|
| | Feather | | Weight loss rate | Weight-loss | | | |
| | weight | | after six minutes | termination time | | Appearance of | |
| Example number | (g) | Sample height (inch) | (%) | (sec) | Rating | carbonized film | Overall rating |
| Example 61 | 39.5 | 3.8 | 7.3 | 180 | ◯ | ◯ | ◯ |
| Example 62 | 43.6 | 4.3 | 16.1 | 225 | ◯ | ◯ | ◯ |
| Example 63 | 49.2 | 4.1 | 19.2 | 185 | ◯ | ◯ | ◯ |
| Example 64 | 47.1 | 4.1 | 18.9 | 175 | ◯ | ◯ | ◯ |
| Comparative | 44.4 | 4.1 | 18.4 | 270 | ◯ | Δ | X |
| Example 65 | | | | | | | |
| Comparative | 35.4 | 4.0 | 25.2 | 240 | X | ◯ | X |
| Example 66 | | | | | | | |
| Comparative | 50.5 | 3.9 | 12.1 | 100 | ◯ | Δ | X |
| Example 67 | | | | | | | |
| Comparative | 38.7 | 4.1 | 26.9 | 300 | X | X | X |
| Example 68 | | | | | | | |
| Comparative | 43.3 | 3.8 | 28.0 | 390 | X | Δ | X |
| Example 69 | | | | | | | |
| Comparative | 45.8 | 3.8 | 22.8 | 260 | ◯ | X | X |
| Example 70 | | | | | | | |

### Comparative Examples 65 to 70

### Section 1, Filling Material: Feather

According to the method of preparing a cushion for flame-resistance evaluation (3), a cushion for flame-resistance evaluation was prepared by using each of the plain-weave fabrics prepared in Preparative Examples of woven fabrics 48, 34, 35, 49, 50 and 51 as the surface fabric, and the flame resistance thereof was evaluated. Results are summarized in Table 10.

The flame resistance and the appearance of the carbonized film in the combustion test were favorable in any one of Examples 61 to 64. The cushion of Comparative Example 65, which contained the cotton fiber (C) at a greater rate than those in Examples 61 and 62, had a carbonized film formed but fragile. The cushion of Comparative Example 66, which contained no halogen-containing fiber (A) in contrast to those of Examples 61 and 62, was lower in fabric self-extinguishing characteristics. The cushion of Comparative Example 67, which contained no flame-retardant cellulosic fiber (B) in contrast to those of Examples 61 and 62, gave a fragile carbonized film. The cushion of Comparative Example 68, which contained the polyester fiber (D) in a greater amount than that of Example 63, was lower in fabric self-extinguishing characteristics. The cushion of Comparative Example 69, which contained no halogen-containing fiber (A) in contrast to that of Example 63, was lower in fabric self-extinguishing characteristics. The cushion of Comparative Example 70, which contained no flame-resistant cellulosic fiber (B) in contrast to that of Example 64, gave a fragile carbonized film. The cushions of Examples 61 to 64 were high flame resistant, and superior particularly in comfortableness such as texture, touch feeling, and hygroscopicity, because they contained the cotton fiber (C) and also particularly superior in washing resistance and durability because they contained the polyester fiber (D).

### Examples 65 to 70

### Section 2, Filling Material: Feather

According to the method of preparing a cushion for flame-resistance evaluation (4), a cushion for flame-resistance evaluation was prepared by using each of the plain-weave fabrics (flame-shielding fabrics) prepared in Preparative Examples of woven fabrics 1, 2 and 13 to 16 as the surface fabric, and the flame resistance thereof was evaluated. Results are summarized in Table 11.

TABLE 11
(Section 11, filling material: feather)

| | | Fiber blending ratio in | | | | | Structure of surface | |
|---|---|---|---|---|---|---|---|---|
| | Preparative | surface fabric (wt %) | | | | | fabric | |
| | Example | | Silicic | | | | Amount of | |
| | number of | Halogen- | acid- | | | | flame retardant | |
| Example | woven | containing | containing | Flame-retardant | Cotton | Polyester | in surface fabric | Basis |
| number | fabric | fiber (A) | rayon fiber (B) | rayon fiber (B) | fiber (C) | fiber (D) | (wt %)) | weight (g/m²) |
| Example 65 | 1 | 10 | 15 | 0 | 75 | 0 | 5.8 | 106 |
| Example 66 | 2 | 10 | 0 | 15 | 75 | 0 | 3.8 | 106 |
| Example 67 | 13 | 20 | 5 | 0 | 75 | 0 | 4.1 | 101 |
| Example 68 | 14 | 20 | 0 | 5 | 75 | 0 | 3.4 | 101 |
| Example 69 | 15 | 30 | 60 | 0 | 10 | 0 | 21.9 | 109 |
| Example 70 | 16 | 60 | 30 | 0 | 10 | 0 | 16.8 | 109 |
| Comparative | 25 | 20 | 0 | 0 | 80 | 0 | 2.6 | 104 |
| Example 71 | | | | | | | | |
| Comparative | 26 | 35 | 0 | 0 | 65 | 0 | 4.6 | 108 |
| Example 72 | | | | | | | | |
| Comparative | 27 | 0 | 20 | 0 | 80 | 0 | 6.0 | 104 |
| Example 73 | | | | | | | | |
| Comparative | 28 | 0 | 35 | 0 | 65 | 0 | 10.5 | 108 |
| Example 74 | | | | | | | | |

| | | Combustion test | | | | |
|---|---|---|---|---|---|---|
| | Sample shape | Weight loss rate | Weight-loss | | | |
| Example | Sample | after six | termination | | Appearance of | |
| number | height (inch) | minutes (%) | time (sec) | Rating | carbonized film | Overall rating |
| Example 65 | 4.0 | 0.8 | 60 | ◯ | ◯ | ◯ |
| Example 66 | 4.2 | 3.8 | 70 | ◯ | ◯ | ◯ |
| Example 67 | 4.2 | 1.0 | 90 | ◯ | ◯ | ◯ |
| Example 68 | 3.8 | 1.5 | 70 | ◯ | ◯ | ◯ |
| Example 69 | 4.2 | 0.5 | 20 | ◯ | ◯ | ◯ |
| Example 70 | 4.0 | 0.3 | 20 | ◯ | ◯ | ◯ |
| Comparative | 4.1 | 1.0 | 90 | ◯ | Δ | X |
| Example 71 | | | | | | |
| Comparative | 3.8 | 0.1 | 20 | ◯ | Δ | X |
| Example 72 | | | | | | |
| Comparative | 4.5 | 21.0 | 365 | X | ◯ | X |
| Example 73 | | | | | | |
| Comparative | 4.1 | 10.9 | 380 | Δ | ◯ | X |
| Example 74 | | | | | | |

### Comparative Examples 71 to 74

### Section 2, Filling Material: Feather

According to the method of preparing a cushion for flame-resistance evaluation (4), a cushion for flame-resistance evaluation was prepared by using each of the plain-weave fabrics prepared in Preparative Examples of woven fabrics 25 to 28 as the surface fabric, and the flame resistance thereof was evaluated. Results are summarized in Table 11.

The flame resistance and the appearance of the carbonized film in the combustion test were favorable in any one of Examples 65 to 70. The cushions of Comparative Examples 71 and 72, which did not contain the flame-resistant cellulosic fiber (B), had a carbonized film in unsatisfactory state, compared to those of Examples 65 to 68. The cushions of Comparative Examples 73 and 74, which did not contain the halogen-containing fiber (A), had insufficient fabric self-extinguishing characteristics and demanded an elongated period until extinguishment, compared to those of Examples 69 and 70. The cushions of Examples 65 to 70 were high flame resistant, and superior particularly in comfortableness such as texture, touch feeling, and hygroscopicity, because they contained the cotton fiber (C).

### Examples 71 to 76

### Section 2, Filling Material: Feather

According to the method of preparing a cushion for flame-resistance evaluation (4), a cushion for flame-resistance evaluation was prepared by using each of the plain-weave fabrics (flame-shielding fabrics) prepared in Preparative Examples of woven fabrics 5 to 7 and 17 to 19 as the surface fabric, and the flame resistance thereof was evaluated. Results are summarized in Table 12.

TABLE 12
(Section 2, filling material: feather)

| | | Fiber blending ratio | | | | | Structure of surface | |
|---|---|---|---|---|---|---|---|---|
| | Preparative | in surface fabric (wt %) | | | | | fabric | |
| | Example | | Silicic | | | | Amount of flame | |
| | number of | Halogen- | acid- | | | | retardant in | |
| Example | woven | containing | containing | Post-processed | Cotton | Polyester | surface fabric | Basis weight |
| number | fabric | fiber (A) | rayon fiber (B) | rayon fiber (B) | fiber (C) | fiber (D) | (wt %)) | (g/m²) |
| Example 71 | 5 | 5 | 45 | 0 | 0 | 50 | 14.2 | 104 |
| Example 72 | 6 | 45 | 5 | 0 | 0 | 50 | 7.4 | 104 |
| Example 73 | 7 | 45 | 0 | 5 | 0 | 50 | 6.7 | 104 |
| Example 74 | 17 | 30 | 60 | 0 | 0 | 10 | 21.9 | 109 |
| Example 75 | 18 | 30 | 0 | 60 | 0 | 10 | 13.9 | 109 |
| Example 76 | 19 | 60 | 30 | 0 | 0 | 10 | 16.8 | 109 |
| Comparative | 29 | 40 | 0 | 0 | 0 | 60 | 5.2 | 104 |
| Example 75 | | | | | | | | |
| Comparative | 30 | 50 | 0 | 0 | 0 | 50 | 6.5 | 103 |
| Example 76 | | | | | | | | |
| Comparative | 31 | 0 | 40 | 0 | 0 | 60 | 12.0 | 104 |
| Example 77 | | | | | | | | |
| Comparative | 32 | 0 | 50 | 0 | 0 | 50 | 15.0 | 103 |
| Example 78 | | | | | | | | |

| | | Combustion test | | | | |
|---|---|---|---|---|---|---|
| | Sample shape | Weight loss rate | Weight-loss | | Appearance | |
| Example | Sample | after six minutes | termination time | | of carbonized | |
| number | height (inch) | (%) | (sec) | Rating | film | Overall rating |
| Example 71 | 3.8 | 14.6 | 235 | ◯ | ◯ | ◯ |
| Example 72 | 4.2 | 15.1 | 200 | ◯ | ◯ | ◯ |
| Example 73 | 3.9 | 18.6 | 210 | ◯ | ◯ | ◯ |
| Example 74 | 4.3 | 2.5 | 25 | ◯ | ◯ | ◯ |
| Example 75 | 4.0 | 2.0 | 25 | ◯ | ◯ | ◯ |
| Example 76 | 4.5 | 0.5 | 20 | ◯ | ◯ | ◯ |
| Comparative | 4.2 | 15.8 | 225 | ◯ | Δ | X |
| Example 75 | | | | | | |
| Comparative | 4.2 | 15.2 | 195 | ◯ | Δ | X |
| Example 76 | | | | | | |
| Comparative | 4.5 | 23.4 | 380 | X | ◯ | X |
| Example 77 | | | | | | |
| Comparative | 4.0 | 21.8 | 300 | X | ◯ | X |
| Example 78 | | | | | | |

### Comparative Examples 75 to 78

### Section 2, Filling Material: Feather

According to the method of preparing a cushion for flame-resistance evaluation (4), a cushion for flame-resistance evaluation was prepared by using each of the plain-weave fabrics prepared in Preparative Examples of woven fabrics 29 to 32 as the surface fabric, and the flame resistance thereof was evaluated. Results are summarized in Table 12.

The flame resistance and the appearance of the carbonized film in the combustion test were favorable in any one of Examples 71 to 76. The cushions of Comparative Examples 75 and 76, which contained the halogen-containing fiber (A) in sufficient amount, had favorable self-extinguishing characteristics, but had a carbonized film in an unfavorable state, because they did not contain the flame-retardant cellulosic fiber (B). The cushions of Comparative Examples 77 and 78, which contained the silicic acid-containing rayon fiber (B) in sufficient amount, had a carbonized film in favorable state, but showed unfavorable fabric self-extinguishing characteristics, because they did not contain the halogen-containing fiber (A). The cushions of Examples 71 to 76, which were highly flame-resistant, had a texture and touch feeling of the fiber favorable as the raw material for flame-shielding fabric, and contained the polyester fiber (D), were particularly superior in washing resistance and durability.

### Examples 77 to 80

### Section 2, Filling Material: Feather

According to the method of preparing a cushion for flame-resistance evaluation (4), a cushion for flame-resistance evaluation was prepared by using each of the plain-weave fabrics (flame-shielding fabrics) prepared in Preparative Examples of woven fabrics 9, 10, and 20 to 21 as the surface fabric, and the flame resistance thereof was, evaluated. Results are summarized in Table 13.

TABLE 13
(Section 2, filling material: feather)

| | | Fiber blending ratio in | | | | | Structure of | |
|---|---|---|---|---|---|---|---|---|
| | Preparative | surface fabric (wt %) | | | | | surface fabric | |
| | Example | | Silicic | | | | Amount | |
| | number of | Halogen- | acid-containing | | | | of | Basis |
| Example | woven | containing | rayon | Post-processed | Cotton | Polyester | flame | weight |
| number | fabric | fiber (A) | fiber (B) | rayon fiber (B) | fiber (C) | fiber (D) | retardant in | (g/m²) |
| Example 77 | 9 | 5 | 5 | 0 | 75 | 15 | 2.2 | 104 |
| Example 78 | 10 | 5 | 0 | 5 | 75 | 15 | 1.5 | 104 |
| Example 79 | 20 | 5 | 5 | 0 | 40 | 50 | 2.2 | 102 |
| Example 80 | 21 | 15 | 15 | 0 | 40 | 30 | 6.5 | 106 |
| Comparative | 48 | 5 | 5 | 0 | 80 | 10 | 2.2 | 108 |
| Example 79 | | | | | | | | |
| Comparative | 34 | 0 | 10 | 0 | 75 | 15 | 3.0 | 104 |
| Example 80 | | | | | | | | |
| Comparative | 35 | 10 | 0 | 0 | 75 | 15 | 1.3 | 104 |
| Example 81 | | | | | | | | |
| Comparative | 49 | 5 | 5 | 0 | 35 | 55 | 2.2 | 106 |
| Example 82 | | | | | | | | |
| Comparative | 50 | 0 | 10 | 0 | 40 | 50 | 3.0 | 106 |
| Example 83 | | | | | | | | |
| Comparative | 51 | 10 | 0 | 0 | 40 | 50 | 1.3 | 106 |
| Example 84 | | | | | | | | |

| | | Combustion test | | | | |
|---|---|---|---|---|---|---|
| | Sample shape | Weight loss | Weight-loss | | | |
| Example | Sample | rate after six | termination | | Appearance of | |
| number | height (inch) | minutes (%) | time (sec) | Rating | carbonized film | Overall rating |
| Example 77 | 4.3 | 3.5 | 195 | ◯ | ◯ | ◯ |
| Example 78 | 3.9 | 5.8 | 200 | ◯ | ◯ | ◯ |
| Example 79 | 4.2 | 19.6 | 285 | ◯ | ◯ | ◯ |
| Example 80 | 3.8 | 14.6 | 155 | ◯ | ◯ | ◯ |
| Comparative | 4.1 | 21.2 | 255 | ◯ | Δ | X |
| Example 79 | | | | | | |
| Comparative | 4.5 | 25.2 | 265 | X | ◯ | X |
| Example 80 | | | | | | |
| Comparative | 3.8 | 14.7 | 135 | ◯ | Δ | X |
| Example 81 | | | | | | |
| Comparative | 4.1 | 32.4 | 335 | X | X | X |
| Example 82 | | | | | | |
| Comparative | 4.0 | 33.5 | 420 | X | Δ | X |
| Example 83 | | | | | | |
| Comparative | 4.2 | 26.9 | 380 | X | X | X |
| Example 84 | | | | | | |

### Comparative Examples 79 to 84

### Section 2, Filling Material: Feather

According to the method of preparing a cushion for flame-resistance evaluation (4), a cushion for flame-resistance evaluation was prepared by using each of the plain-weave fabrics prepared in Preparative Examples of woven fabrics 48, 34, 35 and 49 to 51 as the surface fabric, and the flame resistance thereof was, evaluated. Results are summarized in Table 13.

The flame resistance and the appearance of the carbonized film in the combustion test were favorable in any one of Examples 77 to 80. The cushion of Comparative Example 79, which contained the cotton fiber (C) in a greater amount, gave a fragile carbonized film, compared to those of Examples 77 and 78. The cushion of Comparative Example 80, which did not contain the halogen-containing fiber (A), had lower fabric self-extinguishing characteristics than to those of Examples 77 and 78. The cushion of Comparative Example 81, which did not contain the flame-resistant cellulosic fiber (B), had a carbonized film in unsatisfactory state, compared to those of Examples 77 and 78. The cushion of Comparative Example 82, which contained the polyester fiber (D) in a greater amount, was lower in fabric self-extinguishing characteristics, compared to that of Example 79. The cushion of Comparative Example 83, which did not contain the halogen-containing fiber (A), was lower in fabric self-extinguishing characteristics, compared to that of Example 79. The cushion of Comparative Example 84, which contained no flame-retardant cellulosic fiber (B), gave a fragile carbonized film, compared to that of Example 80. The cushions of Examples 77 to 80 were highly flame resistant and particularly superior in comfortableness such as texture, touch feeling, and hygroscopicity because they contained the cotton fiber (C), and particularly superior also in washing resistance and durability because they contained the polyester fiber (D).

### INDUSTRIAL APPLICABILITY

The flame-retardant bedding product according to the present invention is a bedding product that is produced by a enclosing filling material such as cotton, polyester fiber, or feather with a flame-shielding fabric and has the sufficient softness and comfortableness inherent to the raw filling material and is superior in texture, touch feeling, hygroscopicity, and others and higher in flame resistance.

1. A flame-retardant bedding product, comprising an internal filling material and a flame-shielding fabric enclosing the filling material, wherein said flame-shielding fabric is made of a fiber containing 5 to 60 wt % of a halogen-containing fiber (A), 5 to 60 wt % of a flame-retardant cellulosic fiber (B), 0 to 75 wt % of a cellulosic fiber (C), and 0 to 50 wt % of a polyester fiber (D).

2. The flame-retardant bedding product according to claim 1, wherein the halogen-containing fiber (A) is a modacrylic fiber.

3. The flame-retardant bedding product according to claim 1, wherein the flame-retardant cellulosic fiber (B) is at least one fiber selected from the group consisting of cotton, hemp, rayon, polynosic, cupra, acetate and triacetate that contains a flame retardant.

4. The flame-retardant bedding product according to claim 3, wherein the flame-retardant cellulosic fiber (B) is a rayon fiber containing a flame retardant selected from silicic acid and aluminum silicate in an amount of 20 to 50 wt %.

5. The flame-retardant bedding product according to claim 3, wherein the flame-retardant cellulosic fiber (B) is a fiber containing at least one flame retardant selected from the group consisting of phosphate ester compounds, halogen-containing phosphate ester compounds, condensed phosphate ester compounds, polyphosphate salt compounds, red phosphorus, amine compounds, boric acid, halogen compounds, bromides, urea-formaldehyde compounds, phosphoric acid salt-urea compounds, and ammonium sulfate as deposited in an amount of 6 to 25 wt % with respect to the cellulosic fiber.

6. The flame-retardant bedding product according to claim 1, wherein the cellulosic fiber (C) is at least one fiber selected from the group consisting of cotton, hemp, rayon, polynosic, cupra, acetate, and triacetate.

7. The flame-retardant bedding product according to claim 6, wherein the cellulosic fiber (C) is at last one fiber selected from the group consisting of cotton, hemp, and rayon.

8. The flame-retardant bedding product according to claim 1, wherein the polyester fiber (D) is a polyester-based low-melting-point binder fiber or a fiber containing a common polyester fiber and a low-melting-point binder fiber.

9. The flame-retardant bedding product according to claim 8, wherein the low-melting-point binder fiber in the polyester fiber (D) is at least one fiber selected from the group consisting of a single-component low-melting-point polyester fibers, composite fibers of a common polyester and a low-melting-point polyester, and composite fibers of a common polyester and a low-melting-point polyolefin.

10. The flame-retardant bedding product according to claim 1, wherein the flame-shielding fabric contains the flame retardant in an amount of 1.0 to 40 wt %.

11. The flame-retardant bedding product according to claim 1, wherein the flame-shielding fabric contains a Sb compound in an amount of 0.2 to 20 wt %.

12. The flame-retardant bedding product according to claim 1, wherein the filling material is at least one material selected from the group consisting of cellulosic fiber, polyester fiber, and feather.

13. The flame-retardant bedding product according to claim 1, wherein the filling material is a bulky polyester fiber.

14. The flame-retardant bedding product according to claim 1, wherein the basis weight of the flame-shielding fabric is 150 g/m² or less.

15. The flame-retardant bedding product according to claim 1, wherein the flame-shielding fabric enclosing the filling material is at least one material selected from the group consisting of woven fabric, knitted fabric, and nonwoven fabric.

16. The flame-retardant bedding product according to claims 15, wherein the flame-shielding fabric is a woven or knitted fabric that is used as the surface fabric of the bedding product.

17. The flame-retardant bedding product according to claim 15, wherein the flame-shielding fabric is a nonwoven fabric that is used as the internal fabric held between the surface fabric and the filling material
